(19) United States
(12) Patent Application Publication
(10) Pub. No.: US 2023/0272206 A1
(43) Pub. Date: Aug. 31, 2023

(54) CROSSLINKABLE OLEFIN/SILANE INTERPOLYMER COMPOSITIONS

(71) Applicant: Dow Global Technologies LLC, Midland, MI (US)

(72) Inventors: Gaoxiang Wu, Pearland, TX (US); Yabin Sun, Shanghai (CN); Shuqi Lai, Midland, MI (US); Bethany M. Neilson, Manvel, TX (US); Colin Li Pi Shan, Pearland, TX (US); David S. Laitar, Midland, MI (US); Jordan C. Reddel, Midland, MI (US)

(73) Assignee: Dow Global Technologies LLC, Midland, MI (US)

(21) Appl. No.: 18/013,229

(22) PCT Filed: Jun. 23, 2021
(86) PCT No.: PCT/US2021/038562

§ 371 Date: Dec. 27, 2022

(30) Foreign Application Priority Data
Jun. 24, 2020 (WO) PCT/CN2020/098045

(51) Int. Cl. C08L 51/06; C08K 5/14

(52) U.S. Cl. CPC C08L 51/06; C08K 5/14

(57) ABSTRACT

A process to form a crosslinked composition, the process comprising thermally treating a composition that comprises the following components: a) at least one olefin/silane interpolymer comprising at least one Si—H group, b) at least one peroxide, and c) optionally, at least one crosslinking coagent. A composition that comprises the following components: a) at least one olefin/silane interpolymer comprising at least one Si—H group, b) at least one peroxide, and c) optionally, at least one crosslinking coagent.

### CROSS-REFERENCE TO RELATED APPLICATIONS

This application claims the benefit of priority to International Application No. PCT/CN2020/098045, filed on Jun. 24, 2020, which is incorporated herein by reference in its entirety.

### BACKGROUND OF THE INVENTION

Peroxide initiated crosslinking, functionalization and rheology modification is widely used in olefin-based polymer applications. The reaction characteristics (for example, efficiency, curing speed, and reaction selectivity) are crucial factors that can largely affect the polymer formulation, part processing and part performance. For example, an olefin-based polymer with an improved rate and effectiveness of crosslinking can help customers to reduce the cycle time of part manufacturing and/or minimize the usage of costly curing additives in the formulation. There is a need for olefin-based polymer compositions that can be crosslinked at improved (faster) crosslinking rates and improved crosslinking efficiencies (higher degrees of crosslinking).

U.S. Pat. No. 10,308,829 discloses polymeric compositions comprising a polyolefin having hydrolyzable silane groups, an organic peroxide, and optionally, a catalyst (see abstract) to catalyze hydrolyzation and condensation. A second step crosslinking was observed in the presence of a silanol condensation catalyst (for example, a sulfonic acid or a blocked sulfonic acid) to further link the hydrolysable silane groups in the polymer chain, to generate enhanced crosslinking efficiency. Hydrolyzable silane groups include alkoxy groups, aryloxy groups, aliphatic acyloxy groups, amino or substituted amino groups, and lower alkyl groups (see, for example, column 4, lines 30-49).

U.S. Pat. No. 5,741,858 discloses a silane-crosslinked blend comprising the following: a) a polyolefin elastomer with a density less than 0.885 g/cc, b) a crystalline polyolefin, and c) a silane crosslinker (see claim 1). Suitable silanes contain hydrolyzable groups, such as alkoxy groups, aryloxy groups, aliphatic acyloxy groups, amino or substituted amino groups, and lower alkyl groups (see, for example, column 1, lines 44-60). The silane is typically grafted onto the elastomer backbone, thus requiring an additional processing step, prior to crosslinking. The crosslinking of the silane grafted polymers is promoted with a catalyst.

U.S. Publication 2019/0225786 discloses a composition comprising polyethylene, a multifunctional coagent, and a free radical generator (see abstract). Such compositions may be used to form modified and crosslinked polyethylene. U.S. Pat. No. 6,624,254 discloses the syntheses of silane functionalized polymers, and polymer conversions through coupling, hydrolysis, hydrolysis and neutralization, condensation, oxidation and hydrosilation (see abstract). See also, U.S. Pat. No. 6,258,902. Silyl-terminated polyolefins and/or silane functionalized polyolefins are disclosed in the following references: U.S. Pat. Nos. 6,075,103; 5,578,690; H. Makio et al., Silanolytic Chain Transfer in Olefin Polymerization with Supported Single-Site Ziegler-Natta Catalysts, Macromolecules, 2001, 34, 4676-4679; S. B. Amin et al., Alkenylsilane Effects on Organotitanium-Catalyzed Ethylene Polymerization Toward Simultaneous Polyolefin Branch and Functional Group Introduction, J. Am. Chem. Soc., 2006, 128, 4506-4507.

However, there remains a need for new olefin-based polymer compositions and crosslinking process of the same, that result in high crosslinking rates and efficiencies. These needs have been met by the following invention.

### SUMMARY OF THE INVENTION

A process to form a crosslinked composition, the process comprising thermally treating a composition that comprises the following components:
a) at least one olefin/silane interpolymer comprising at least one Si—H group,
b) at least one peroxide, and
c) optionally, at least one crosslinking coagent.

A composition that comprises the following components:
a) at least one olefin/silane interpolymer comprising at least one Si—H group,
b) at least one peroxide, and
c) optionally, at least one crosslinking coagent.

### BRIEF DESCRIPTION OF THE DRAWINGS

FIG. 1 depicts MDR profiles (Torque vs. Time) for inventive compositions IE-1 and IE-2 and comparative compositions CE-1 and CE-2.

### DETAILED DESCRIPTION OF THE INVENTION

Compositions containing olefin/silane interpolymers have been discovered that provide the following distinctive features, and related benefits: a) improved curing effectiveness under low peroxide loading, which allows for a reduction in peroxide loading for cost saving and reduced peroxide side-reactions; b) improved curing rate, which allows for a reduction in cycle time, an increase in the throughput of manufactured parts, and a reduction in the variable cost in equipment; c) selective formation of chemical bonding with the —SiH functional groups, which allows for the design of distinctive polymer network microstructures with tailored properties.

Processes to effectively cure these compositions have also been discovered. Also, it has been discovered that the silicon hydride functional groups can readily react with peroxide, to form a sufficiently crosslinked interpolymer, without the need for an additional cure catalyst. It has also been discovered that even a small fraction (for example, ≤5.0 wt %) of the incorporated silane comonomer greatly improves the crosslinking effectiveness of the composition, as compared to the crosslinking of ethylene-based polymers using conventional crosslinking methods.

As discussed, in a first aspect, a process to form a crosslinked composition is provided, which comprises thermally treating a composition that comprises the following components:
a) at least one olefin/silane interpolymer comprising at least one Si—H group,
b) at least one peroxide, and
c) optionally, at least one crosslinking coagent.

The above process may comprise a combination of two or more embodiments, as described herein. Each component a, b and c may comprise a combination of two or more embodiments, as described herein.

Also provided, in a second aspect, is a composition that comprises the following components:
a) at least one olefin/silane interpolymer comprising at least one Si—H group,
b) at least one peroxide, and
c) optionally, at least one crosslinking coagent.

The above composition may comprise a combination of two or more embodiments, as described herein. Each component a, b and c may comprise a combination of two or more embodiments, as described herein.

The following embodiments apply to both the first aspect and the second aspect of the invention, unless stated otherwise.

In one embodiment, or a combination of two or more embodiments, each described herein, the olefin/silane interpolymer of component a is an ethylene/alpha-olefin/silane interpolymer, and further an ethylene/alpha-olefin/silane terpolymer.

In one embodiment, or a combination of two or more embodiments, each described herein, the composition comprises only one olefin/silane interpolymer for component a, and further only one ethylene/alpha-olefin/silane interpolymer, and further only one ethylene/alpha-olefin/silane terpolymer.

In one embodiment, or a combination of two or more embodiments, each described herein, the interpolymer of component a comprises, in polymerized form, ≥0.10 wt %, or ≥0.20 wt %, or ≥0.30 wt %, or ≥0.40 wt %, or ≥0.50 wt %, or ≥0.60 wt %, or ≥0.70 wt %, or ≥0.80 wt %, or ≥0.90 wt %, or ≥1.0 wt % of the silane, based on the weight of the interpolymer.

In one embodiment, or a combination of two or more embodiments, each described herein, the interpolymer of component a comprises, in polymerized form, ≤40 wt %, or ≤30 wt %, or ≤20 wt %, or ≤10 wt %, or ≤8.0 wt %, or ≤6.0 wt %, or ≤4.0 wt % of the silane, based on the weight of the interpolymer. In one embodiment, or a combination of two or more embodiments, each described herein, the interpolymer of component a comprises, in polymerized form, ≤5.0 wt %, or ≤4.5 wt %, or ≤4.0 wt %, or ≤3.8 wt %, or ≤3.6 wt %, or ≤3.4 wt %, or ≤3.2 wt %, or ≤3.0 wt % of the silane, based on the weight of the interpolymer.

In one embodiment, or a combination of two or more embodiments, each described herein, the interpolymer of component a has a molecular weight distribution (MWD=Mw/Mn)≥1.5, or ≥1.6, or ≥1.7, or ≥1.8, or ≥1.9. In one embodiment, or a combination of two or more embodiments, each described herein, the interpolymer of component a has a molecular weight distribution MWD ≤5.0, or ≤4.5, or ≤4.0, or ≤3.5, or ≤3.0, or ≤2.9, or ≤2.8, or ≤2.7, or ≤2.6, or ≤2.5, or ≤2.4, or ≤2.3.

In one embodiment, or a combination of two or more embodiments, each described herein, the silane is derived from a silane monomer selected from Formula 1:

A-(SiBC—O)ₓ—Si-EFH (Formula 1),

where A is an alkenyl group;

B is a hydrocarbyl group or hydrogen, C is a hydrocarbyl group or hydrogen, and where B and C may be the same or different, and further B is a hydrocarbyl group, C is a hydrocarbyl group, and further B and C are the same;

H is hydrogen, and x ≥0;

E is a hydrocarbyl group or hydrogen, F is a hydrocarbyl group or hydrogen, and where E and F may be the same or different, and further E is a hydrocarbyl group, F is a hydrocarbyl group, and further E and F are the same.

In one embodiment, or a combination of two or more embodiments, each described herein, Formula 1 is selected from the following compounds s1) through s16) below:

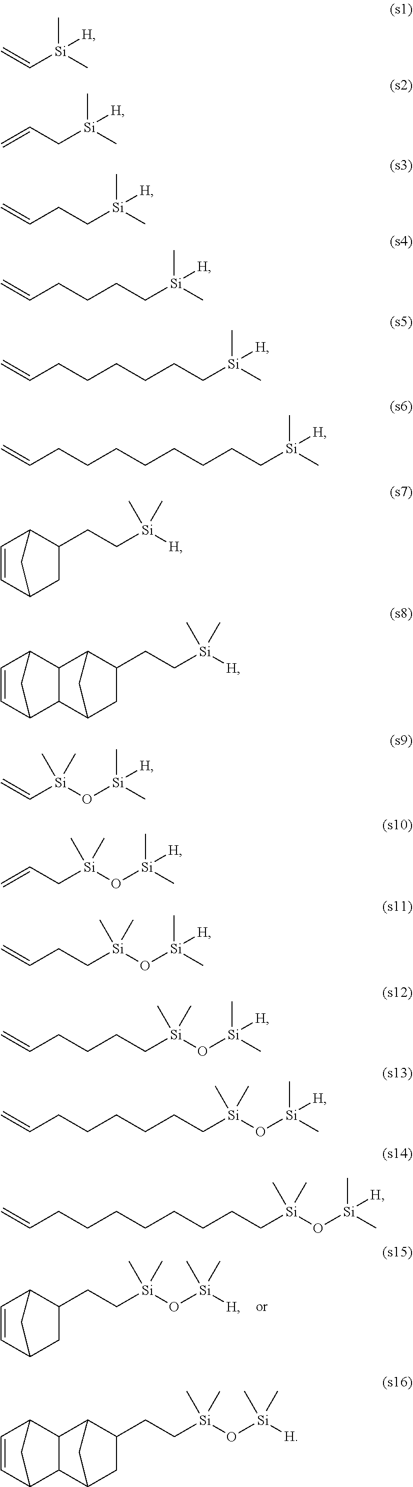

In one embodiment, or a combination of two or more embodiments, each described herein, the composition has a mole ratio of “the active oxygen atom in component b” to component a ≥0.5, or ≥0.7, or ≥1.0, or ≥1.5, or ≥2.0, or ≥2.5, or ≥3.0, or ≥3.5, or ≥4.0.

In one embodiment, or a combination of two or more embodiments, each described herein, the composition has a mole ratio of “the active oxygen atom in component b” to component a ≤30, or ≤25, or ≤20, or ≤15, or ≤12, or ≤10, or ≤7.5, or ≤5.5.

In one embodiment, or a combination of two or more embodiments, each described herein, the composition has a mole ratio component c to “the active oxygen atom in component b” ≥0, or ≥0.01, or ≥0.05, or ≥0.10, or ≥0.15, or ≥0.20. In one embodiment, or a combination of two or more embodiments, each described herein, the composition has a mole ratio component c to “the active oxygen atom in component b”≤10.00, or ≤7.50, or ≤5.00, or ≤2.50, or ≤1.00, or ≤0.75, or ≤0.50.

In one embodiment, or a combination of two or more embodiments, each described herein, the composition further comprises an ethylene/alpha-olefin interpolymer, and further an ethylene/alpha-olefin copolymer.

In one embodiment, or a combination of two or more embodiments, each described herein, the composition is thermally treated at a temperature ≥120° C., or ≥130° C., or ≥140° C., or ≥150° C. In one embodiment, or a combination of two or more embodiments, each described herein the composition is thermally treated at a temperature ≤200° C., or ≤195° C., or ≤190° C., or ≤185° C., or ≤180° C.

Also is provided a crosslinked composition formed by an inventive process as described herein, or from an inventive composition as described herein.

Also provided is an article comprising at least one component formed from a composition of any one embodiment, or a combination of two or more embodiments, each described herein. In one embodiment, or a combination of two or more embodiments, each described herein, the article is a film. In one embodiment, or a combination of two or more embodiments, each described herein, the article is a solar cell module, a cable, a footwear component, an automotive part, a window profile, a tire, a tube/hose, or a roofing membrane.

Silane Monomer A silane monomer, as used herein, comprises at least one (type) Si—H group. In one embodiment, the silane monomer is selected from Formula 1, as discussed above.

Some examples of silane monomers include hexenylsilane, allylsilane, vinylsilane, octenylsilane, hexenyldimethylsilane, octenyldimethylsilane, vinyldimethylsilane, vinyldiethylsilane, vinyldi(n-butyl)silane, vinylmethyloctadecylsilane, vinyidiphenylsilane, vinyldibenzylsilane, allyldimethylsilane, allyldiethylsilane, allyldi(n-butyl)silane, allylmethyloctadecylsilane, allyldiphenylsilane, bishexenylsilane, and allyidibenzylsilane. Mixtures of the foregoing alkenylsilanes may also be used.

More specific examples of silane monomers include the following: (5-hexenyl-dimethylsilane (HDMS), 7-octenyldimethylsilane (ODMS), allyldimethylsilane (ADMS), 3-butenyldimethylsilane, 1-(but-3-en-1-yl)-1,1,3,3-tetramethyldisiloxane (BuMMH), 1-(hex-5-en-1-yl)-1,1,3,3-tetramethyldisiloxane (HexMMH), (2-bicyclo[2.2.1]hept-5-en-2-yl)ethyl)-dimethylsilane (NorDMS) and 1-(2-bicyclo[2.2.1]hept-5-en-2-yl)ethyl)-1,1,3,3-tetramethyldisiloxane (NorMMH). Mixtures of the foregoing alkenylsilanes may also be used.

### Peroxide

As noted above, the composition comprises a peroxide. As used herein, a peroxide contains at least one oxygen-oxygen bond (O—O). Peroxides include, but are not limited to, dialkyl, diaryl, dialkaryl, or diaralkyl peroxide, having the same or differing respective alkyl, aryl, alkaryl, or aralkyl moieties, and further each dialkyl, diaryl, dialkaryl, or diaralkyl peroxide, having the same respective alkyl, aryl, alkaryl, or aralkyl moieties.

Exemplary organic peroxides include dicumyl peroxide (“DCP”); tert-butyl peroxybenzoate; di-tert-amyl peroxide (“DTAP”); bis(t-butyl-peroxy isopropyl) benzene (“BIPB”); isopropylcumyl t-butyl peroxide; t-butylcumylperoxide; di-t-butyl peroxide; 2,5-bis(t-butylperoxy)-2,5-dimethylhexane; 2,5-bis(t-butylperoxy)-2,5-dimethylhexyne-3; 1,1-bis(t-butylperoxy)3,3,5-trimethylcyclohexane; isopropylcumyl cumylperoxide; butyl 4,4-di(tert-butylperoxy)valerate; di(isopropylcumyl) peroxide; 1,1-di-(tert-butylperoxy)cyclohexane (“Luperox 331”); 1,1-di-(tert-amylperoxy)cyclohexane (“Luperox 531”); tert-butylperoxyacetate (“TBPA”); tert-amyl peroxyacetate (“TAPA”); 2,5-dimethyl-2,5-di(tert-butylperoxy)hexane (“Luperox 101”); tert-Butylperoxy-2-ethylhexyl carbonate (“TBEC”); and mixtures of two or more thereof.

In one or more embodiments, the peroxide may be a cyclic peroxide. An example of a cyclic peroxide is represented by the following Formula 2:

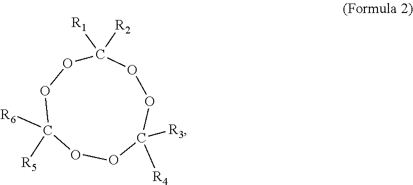

wherein R1-R6 are each independently hydrogen or an inertly-substituted or unsubstituted C1-C20 alkyl, C3-C20 cycloalkyl, C6-C20 aryl, C7-C20 aralkyl, or C7-C20 alkaryl. Representative of the inert-substituents included in R1-R6 are hydroxyl, C1-C20 alkoxy, linear or branched C1-C20 alkyl, C6-C20 aryloxy, halogen, ester, carboxyl, nitrile, and amido. In one or more embodiments, R1-R6 are each independently lower alkyls, including, for example, a C1-C10 alkyl, or a C1-C4 alkyl.

A number of cyclic peroxides are commercially available, for example, under the tradename TRIGONOX, such as 3,6,9-triethyl-3,6,9-trimethyl-1,4,7-triperoxonane. Examples of cyclic peroxides include those derived from acetone, methylamyl ketone, methylheptyl ketone, methylhexyl ketone, methylpropyl ketone, methylbutyl ketone, diethyl ketone, methylethyl ketone, methyloctyl ketone, methylnonyl ketone, methyldecyl ketone, methylundecyl ketone and combinations thereof, among others. The cyclic peroxides can be used alone or in combination with one another.

In one or more embodiments, the peroxide is 3,6,9-triethyl-3-6-9-trimethyl-1,4,7-triperoxonane, which is commercially available from AkzoNobel under the trade designation TRIGONOX 301. In one or more embodiments, the peroxide is dicumyl peroxide. The peroxide can be liquid, solid, or paste.

Crosslinking Coagent

As used herein, a “crosslinking coagent” is a compound that promotes crosslinking; for example, by helping to establish a higher concentration of reactive sites and/or helping to reduce the chance of deleterious radical side reactions. Crosslinking coagents include, but are not limited to, triallyl cyanurate (TAC), triallyl phosphate (TAP), triallyl isocyanurate (TAIC), 1,3,5,7-tetravinyl-1,3,5,7-tetramethylcyclotetrasiloxane (Vinyl D4), 2,4,6-trimethyl-2,4,6-trivinyl-1,3,5,2,4,6-trioxatrisilinane (Vinyl D3), 2,4,6,8,10-pentamethyl-2,4,6,8,10-pentavinyl-1,3,5,7,9,2,4,6,8,10-pentaoxapentasilecane (Vinyl D5), dipentaerythritolpenta-acrylate and trimethylolpropane triacrylate, triallyl trimellitate; N,N,N′,N′,N″,N″-hexaallyl-1,3,5-triazine-2,4,6-triamine; triallyl orthoformate; pentaerythritol triallyl ether; triallyl citrate; triallyl aconitate; trimethylolpropane triacrylate; trimethylolpropane trimethylacrylate; ethoxylated bisphenol A dimethacrylate; 1,6-hexanediol diacrylate; pentaerythritol tetraacrylate; dipentaerythritol pentaacrylate; tris(2-hydroxyethyl) isocyanurate triacrylate; propoxylated glyceryl triacrylate; a polybutadiene having at least 50 wt % 1,2-vinyl content; trivinyl cyclohexane; certain dicarbonyl species, e.g., 1,3-diacetylbenzene (DAB); and mixtures of any two or more thereof.

### Additives

An inventive composition may comprise one or more additives. Additives include, but are not limited to, UV stabilizer, antioxidants, fillers, scorch retardants, tackifiers, waxes, compatibilizers, adhesion promoters, plasticizers (for example, oils), blocking agents, antiblocking agents, anti-static agents, release agents, anti-cling additives, colorants, dyes, pigments, and combination thereof.

### Definitions

Unless stated to the contrary, implicit from the context, or customary in the art, all parts and percents are based on weight, and all test methods are current as of the filing date of this disclosure.

The term “composition,” as used herein, includes a mixture of materials, which comprise the composition, as well as reaction products and decomposition products formed from the materials of the composition. Any reaction product or decomposition product is typically present in trace or residual amounts.

The term “polymer,” as used herein, refers to a polymeric compound prepared by polymerizing monomers, whether of the same or a different type. The generic term polymer thus, includes the term homopolymer (employed to refer to polymers prepared from only one type of monomer, with the understanding that trace amounts of impurities can be incorporated into the polymer structure), and the term interpolymer as defined hereinafter. Trace amounts of impurities, such as catalyst residues, can be incorporated into and/or within the polymer. Typically, a polymer is stabilized with very low amounts (“ppm” amounts) of one or more stabilizers.

The term “interpolymer,” as used herein, refers to polymer prepared by the polymerization of at least two different types of monomers. The term interpolymer thus includes the term copolymer (employed to refer to polymers prepared from two different types of monomers) and polymers prepared from more than two different types of monomers.

The term “olefin-based polymer,” as used herein, refers to a polymer that comprises, in polymerized form, 50 wt % or a majority weight percent of an olefin, such as ethylene or propylene (based on the weight of the polymer), and optionally may comprise one or more comonomers.

The term “propylene-based polymer,” as used herein, refers to a polymer that comprises, in polymerized form, a majority weight percent of propylene (based on the weight of the polymer), and optionally may comprise one or more comonomers.

The term “ethylene-based polymer,” as used herein, refers to a polymer that comprises, in polymerized form, 50 wt % or a majority weight percent of ethylene (based on the weight of the polymer), and optionally may comprise one or more comonomers.

The term “ethylene/alpha-olefin interpolymer,” as used herein, refers to a random interpolymer that comprises, in polymerized form, 50 wt % or a majority weight percent of ethylene (based on the weight of the interpolymer), and an alpha-olefin.

The term, “ethylene/alpha-olefin copolymer,” as used herein, refers to a random copolymer that comprises, in polymerized form, 50 wt % or a majority weight percent of ethylene (based on the weight of the copolymer), and an alpha-olefin, as the only two monomer types.

The term “olefin/silane interpolymer,” as used herein, refers to a random interpolymer that comprises, in polymerized form, 50 wt % or a majority weight percent of an olefin (based on the weight of the interpolymer), and a silane monomer. As used herein, the interpolymer comprises at least one Si—H group, and the phrase “at least one Si—H group” refers to a type of “Si—H” group. It is understood in the art that the interpolymer would contain a multiple number of these groups. The olefin/silane interpolymer is formed by the copolymerization (for example, using a bis-biphenyl-phenoxy metal complex) of at least the olefin and the silane monomer. An example of a silane monomer is depicted in Formula 1, as described above.

The term “ethylene/silane interpolymer,” as used herein, refers to a random interpolymer that comprises, in polymerized form, 50 wt % or a majority weight percent of ethylene (based on the weight of the interpolymer), and a silane monomer. As used herein, the interpolymer comprises at least one Si—H group, and the phrase “at least one Si—H group,” as discussed above. The ethylene/silane interpolymer is formed by the copolymerization of at least the ethylene and the silane monomer.

The term “ethylene/alpha-olefin/silane interpolymer,” as used herein, refers to a random interpolymer that comprises, in polymerized form, 50 wt % or a majority weight percent of ethylene (based on the weight of the interpolymer), an alpha-olefin and a silane monomer. As used herein, these interpolymer comprises at least one Si—H group, as discussed above. The ethylene/silane interpolymer is formed by the copolymerization of at least the ethylene, the alpha-olefin and the silane monomer.

The term “ethylene/alpha-olefin/silane terpolymer,” as used herein, refers to a random terpolymer that comprises, in polymerized form, 50 wt % or a majority weight percent of ethylene (based on the weight of the terpolymer), an alpha-olefin and a silane monomer as the only three monomer types. As used herein, the terpolymer comprises at least one Si—H group, as discussed above. The ethylene/silane terpolymer is formed by the copolymerization of the ethylene, the alpha-olefin and the silane monomer.

The terms “hydrocarbon group,” “hydrocarbyl group,” and similar terms, as used herein, refer to a chemical group containing only carbon and hydrogen atoms.

The term “crosslinked composition,” as used herein, refers to a composition that has a network structure due to the formation of chemical bonds between polymer chains. The degree of formation of this network structure is indicated by the increase in the “MH-ML” value as discussed herein.

The terms “thermally treating,” “thermal treatment,” and similar terms, as used herein, in reference to a composition comprising an olefin/silane interpolymer, refer to the application of heat to the composition. Heat may be applied by electrical means (for example, a heating coil) and/or by radiation. Note, the temperature at which the thermal treatment takes place, refers to the temperature of the composition (for example, the melt temperature of the composition).

The term “alkenyl group,” as used herein, refers to an organic chemical group that contains at least one carbon-carbon double bond (C═C). In a preferred embodiment, the alkenyl group is a hydrocarbon group containing at least one carbon-carbon double bond, and further containing only one carbon-carbon double bond.

The term “active oxygen atom,” as used herein, refers to the oxygen atoms present as one of two covalently bonded oxygen atoms in the organic peroxide. For example, a mono-functional peroxide has two active oxygen atoms. Oxygen atoms present in the organic peroxide that are not covalently bonded to another oxygen atom are not considered active oxygen atoms. As used herein, “mono-functional peroxides” denote peroxides having a single pair of covalently bonded oxygen atoms (e.g., having a structure R—O—O—R). As used herein, “di-functional peroxides” denote peroxides having two pairs of covalently bonded oxygen atoms (e.g., having a structure R—O—O—R—O—O—R). In an embodiment, the organic peroxide is a mono-functional peroxide.

The mole ratio of the active oxygen atom to polymer is calculated according to the equation below. The mole of polymer is calculated based on Mn of the polymer.

$$\frac{( Mole of peroxide ) ( Number of active oxygen atom per peroixde )}{( Mole of polymer )}$$

The terms “comprising,” “including,” “having,” and their derivatives, are not intended to exclude the presence of any additional component, step or procedure, whether the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation, any other component, step or procedure, excepting those that are not essential to operability. The term “consisting of” excludes any component, step or procedure, not specifically delineated or listed.

### Listing of Some Processes and Compositions

A] A process to form a crosslinked composition, the process comprising thermally treating a composition that comprises the following components:
a) at least one olefin/silane interpolymer comprising at least one (type) Si—H group,
b) at least one peroxide, and
c) optionally, at least one crosslinking coagent.

B] The process of A] above, wherein the olefin/silane interpolymer of component a is an ethylene/alpha-olefin/silane interpolymer, and further an ethylene/alpha-olefin/silane terpolymer.

C] The process of B] above, wherein the alpha-olefin of the ethylene/alpha-olefin/silane interpolymer, and further terpolymer, is a C3-C20 alpha-olefin, further a C3-C10 alpha-olefin, further a C3-C8 alpha-olefin, further propylene, 1-butene, 1-hexene or 1-octene, further propylene, 1-butene, or 1-octene, further 1-butene or 1-octene, further 1-octene. D] The process of any one of A]-C] (A] through C]) above, wherein the interpolymer of component a comprises, in polymerized form, ≥0.10 wt %, or ≥0.20 wt %, or ≥0.30 wt %, or ≥0.40 wt %, or ≥0.50 wt %, or ≥0.60 wt %, or ≥0.70 wt %, or ≥0.80 wt %, or ≥0.90 wt %, or ≥1.0 wt % of the silane, based on the weight of the interpolymer.

E] The process of any one of A]-D] above, wherein the interpolymer of component a comprises, in polymerized form, ≤40 wt %, or ≤30 wt %, or ≤20 wt %, or ≤10 wt %, or ≤8.0 wt %, or ≤6.0 wt %, or ≤4.0 wt % of the silane, based on the weight of the interpolymer.

F] The process of any one of A]-E] above, wherein the interpolymer of component a comprises, in polymerized form, ≤5.0 wt %, or ≤4.5 wt %, or ≤4.0 wt %, or ≤3.8 wt %, or ≤3.6 wt %, or ≤3.4 wt %, or ≤3.2 wt %, or ≤3.0 wt % of the silane, based on the weight of the interpolymer.

G] The process of any one of A]-F] above, wherein the interpolymer of component a has a molecular weight distribution (MWD=Mw/Mn) ≥1.5, or ≥1.6, or ≥1.7, or ≥1.8, or ≥1.9.

H] The process of any one of A]-G] above, wherein the interpolymer of component a has a molecular weight distribution MWD ≤5.0, or ≤4.5, or ≤4.0, or ≤3.5, or ≤3.0, or ≤2.9, or ≤2.8, or ≤2.7, or 2.6, or 2.5, or ≤2.4, or ≤2.3.

I] The process of any one of A]-H] above, wherein the interpolymer of component a has a number average molecular weight (Mn) ≥10,000 g/mol, or ≥12,000 g/mol, or ≥14,000 g/mol, or ≥16,000 g/mol, or ≥18,000 g/mol, or ≥20,000 g/mol, or ≥22,000 g/mol, or ≥24,000 g/mol ≥26,000 g/mol, or ≥28,000 g/mol, or ≥30,000 g/mol, or ≥32,000 g/mol.

J] The process of any one of A]-I] above, wherein the interpolymer of component a has a number average molecular weight (Mn)≤100,000 g/mol, or 95,000 g/mol, or 90,000 g/mol, or ≤85,000 g/mol, or ≤80,000 g/mol, or 75,000 g/mol, or ≤70,000 g/mol, or ≤68,000 g/mol, or ≤66,000 g/mol, or ≤64,000 g/mol, or ≤62,000 g/mol, or ≤60,000 g/mol.

K] The process of any one of A]-J] above, wherein the interpolymer of component a has a weight average molecular weight (Mw) ≥20,000 g/mol, or ≥25,000 g/mol, or ≥30,000 g/mol, or ≥35,000 g/mol, or ≥40,000 g/mol, or ≥45,000 g/mol, or ≥50,000 g/mol, or ≥52,000 g/mol, or ≥54,000 g/mol, or ≥56,000 g/mol, or ≥58,000 g/mol, or ≥60,000 g/mol, or ≥62,000 g/mol.

L] The process of any one of A]-K] above, wherein the interpolymer of component a has a weight average molecular weight (Mw)≤300,000 g/mol, or ≤250,000 g/mol, or ≤200,000 g/mol, or ≤190,000 g/mol, or ≤180,000 g/mol, or ≤170,000 g/mol, or ≤160,000 g/mol, or ≤150,000 g/mol, or ≤148,000 g/mol, or ≤146,000 g/mol, or ≤144,000 g/mol, or ≤142,000 g/mol, or ≤140,000 g/mol, or ≤138,000 g/mol.

M] The process of any one of A]-L] above, wherein the interpolymer of component a has a density ≥0.855 g/cc, or ≥0.856 g/cc, or ≥0.857 g/cc, or ≥0.858 g/cc, or ≥0.859 g/cc, or ≥0.860 g/cc, or ≥0.861 g/cc, or ≥0.862 g/cc, or ≥0.863 g/cc, or ≥0.864 g/cc, or ≥0.865 g/cc, or ≥0.866 g/cc, or ≥0.867 g/cc (1 cc=1 cm³).

N] The process of any one of A]-M] above, wherein the interpolymer of component a has a density ≤0.950 g/cc, or ≤0.920 g/cc, or ≤0.900 g/cc, or ≤0.890 g/cc, or ≤0.888 g/cc, or ≤0.886 g/cc, or ≤0.884 g/cc, or ≤0.882 g/cc, or ≤0.880 g/cc, or ≤0.878 g/cc, or ≤0.876 g/cc, or ≤0.874 g/cc.

O] The process of any one of A]-N] above, wherein the interpolymer of component a has a melt index (I2) ≥0.5 dg/min, or ≥1.0 dg/min, or ≥2.0 dg/min, or ≥5.0 dg/min, or ≥10 dg/min.

P] The process of any one of A]-O] above, wherein the interpolymer of component a has a melt index (I2)≤1,000 dg/min, or ≤500 dg/min, or ≤250 dg/min, or ≤100 dg/min, or ≤50 dg/min, or ≤20 dg/min.

Q] The process of any one of A]-P] above, wherein the interpolymer of component a has an I10/I2 ratio ≥6.0, or ≥7.0, or ≥8.0, or ≥9.0, or ≥10.

R] The process of any one of A]-Q] above, wherein the interpolymer of component a has an I10/I2 ratio ≤30, or ≤25, or ≤20, or ≤15, or ≤12.

S] The process of any one of A]-R] above, wherein silane is derived from a silane monomer selected from Formula 1, as described above.

T] The process of S] above, wherein, for Formula 1, x is from 0 to 10, or from 0 to 8, or from 0 to 6, or from 0 to 4, or from 0 to 2, or 0 or 1, or 0.

U] The process of S] or T] above, wherein, for Formula 1, A is a C2-C50 alkenyl group, and further a C2-C40 alkenyl group, further a C2-C30 alkenyl group, further a C2-C20 alkenyl group.

V] The process of any one of S]-U] above, wherein, for Formula 1, A is selected from the following structures i)-iv):
i) R¹R²C═CR³—, where each of R¹, R² is independently hydrogen or an alkyl group, and R³ is hydrogen, and wherein R¹ and R² may be the same or different;
ii)R¹R²C═CR³—(CR⁴R⁵)ₙ—, where each of R¹, R², R⁴, R⁵ is independently hydrogen, or an alkyl group, and R³ is hydrogen, and wherein two or more from R¹, R², R⁴, R⁵ may be the same or different and n is from 1 to 10, or 1 to 8, or 1 to 6, or 1 to 4, or 1 to 2, or 1;

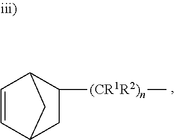

where each of Rand R² is independently hydrogen or an alkyl group, and wherein R¹, and R² may be the same or different, and n is from 1 to 10, or 1 to 8, or 1 to 6, or 1 to 4, or 1 to 2, or 1; or

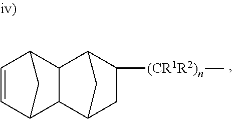

where each of R¹ and R² is independently hydrogen or an alkyl group, and wherein R¹, and R² may be the same or different, and n is from 1 to 10, or 1 to 8, or 1 to 6, or 1 to 4, or 1 to 2, or 1.

W] The process of any one of S]-V] above, wherein, for Formula 1, A is selected from the following structures i)-iv):
i) H₂C═CH—;
ii) H₂C═CH—(CH₂)ₙ—, where n is from 1 to 10, or 1 to 8, or 1 to 6, or 1 to 4, or 1 to 2, or 1;

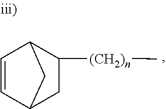

where n is from 1 to 10, or 1 to 8, or 1 to 6, or 1 to 4, or 1 to 2, or 1; or

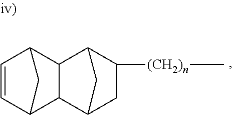

where n is from 1 to 10, or 1 to 8, or 1 to 6, or 1 to 4, or 1 to 2, or 1.

X] The process of any one of S]-W] above, wherein, for Formula 1, B is an alkyl, further a C1-C5 alkyl, further a C1-C4 alkyl, further a C1-C3 alkyl, further a C1-C2 alkyl, further methyl.

Y] The process of any one of S]-X] above, wherein, for Formula 1, C is an alkyl, further a C1-C5 alkyl, further a C1-C4 alkyl, further a C1-C3 alkyl, further a C1-C2 alkyl, further methyl.

Z] The process of any one of S]-Y] above, wherein, for Formula 1, E is an alkyl, further a C1-C5 alkyl, further a C1-C4 alkyl, further a C1-C3 alkyl, further a C1-C2 alkyl, further methyl.

A2] The process of any one of S]-Z] above, wherein, for Formula 1, F is an alkyl, further a C1-C5 alkyl, further a C1-C4 alkyl, further a C1-C3 alkyl, further a C1-C2 alkyl, further methyl.

B2] The process of any one of S]-A2] above, wherein Formula 1 is selected from compounds s1) through s16), as described above.

C2] The process of any one of S]-B2] above, wherein Formula 1 is selected from structures s1) to s8), as described above.

D2] The process of any one of S]-B2] above, wherein Formula 1 is selected from structures s9) to s16), as described above.

E2] The process of any one of A]-D2] above, wherein the silane is derived from a silane monomer selected from the following compounds: allyldimethylsilane, 3-butenyldimethyl-silane, 1-(but-3-en-1-yl)-1,1,3,3-tetramethyl-disiloxane (BuMMH), 1-(hex-5-en-1-yl)-1,1,3,3-tetramethyldisiloxane (HexMMH), (2-bicyclo-[2.2.1]hept-5-en-2-yl)ethyl)dimethyl-silane (NorDMS) or 1-(2-bicyclo[2.2.1]hept-5-en-2-yl)ethyl)-1,1,3,3-tetramethyldisiloxane (NorMMH), or any combination thereof.

F2] The process of any one of A]-E2] above, wherein the composition has a weight ratio of component a to component b ≥20, or ≥25, or ≥30, or ≥35, or ≥40, or ≥45 or ≥50, or ≥55, or ≥60, or ≥65, or ≥70, or ≥75, or ≥80.

G2] The process of any one of A]-F2] above, wherein the composition has a weight ratio of component a to component b≤450, or ≤400 or ≤350, or ≤300, or ≤250, or ≤245, or ≤240, or ≤230, or ≤220, or ≤210 or ≤200, or ≤195, or ≤190, or ≤185.

H2] The process of any one of A]-G2] above, wherein the composition comprises component c (at least one crosslinking coagent).

I2] The process of H2] above, wherein the composition has a weight ratio of component b to component c ≥0.80, or ≥0.85, or ≥0.90, or ≥0.95, or ≥1.00.

J2] The process of H2] or I2] above, wherein the composition has a weight ratio of component b to component c≤3.00, or ≤2.80, or ≤2.60, or ≤2.50, or ≤2.45, or ≤2.40.

K2] The process of any one of A]-J2] above, wherein the composition has a mole ratio of “the active oxygen atom in component b” to component a ≥0.5, or ≥0.7, or ≥1.0, or ≥1.5, or ≥2.0, or ≥2.5, or ≥3.0, or ≥3.5, or ≥4.0, or ≥5.0, or ≥6.0, or ≥7.0, or ≥8.0, or ≥8.5, or ≥10.0, or ≥20, or ≥25, or ≥26.

L2] The process of any one of A]-K2] above, wherein the composition has a mole ratio of “the active oxygen atom in component b” to component a≤50, a≤30, or ≤25, or ≤20, or ≤15, or ≤12, or ≤10, or ≤9.5, or ≤9, or ≤7.5, or ≤5.5.

M2] The process of any one of H2]-L2] above, wherein the composition has a mole ratio component c to “the active oxygen atom in component b” ≥0, or ≥0.01, or ≥0.05, or ≥0.10, or ≥0.15, or ≥0.20.

N2] The process of any one of H2]-M2] above, wherein the composition has a mole ratio component c to “the active oxygen atom in component b”≤10.00, or ≤7.50, or ≤5.00, or ≤2.50, or ≤1.00, or ≤0.75, or ≤0.50.

O2] The process of any one of A]-N2] above, wherein the composition comprises ≥20.0 wt %, ≥30.0 wt %, ≥40.0 wt %, or ≥45.0 wt %, or ≥50.0 wt %, or ≥55.0 wt %, or ≥60.0 wt %, or ≥65.0 wt %, or ≥70.0 wt %, or ≥75.0 wt %, or ≥80.0 wt %, or ≥85.0 wt %, or ≥90.0 wt %, or ≥95.0 wt %, or ≥96.0 wt %, or ≥97.0 wt %, or ≥98.0 wt %, or ≥99.0 wt % of component a, based on the weight of the composition.

P2] The process of any one of A]-02] above, wherein the composition comprises ≤99.9 wt %, or ≤99.8 wt %, or ≤99.6 wt %, or ≤99.4 wt %, or ≤99.2 wt %, or ≤99.0 wt %, or ≤95.0 wt %, or ≤90.0 wt %, or ≤85.0 wt %, or ≤80.0 wt %, or ≤75.0 wt %, or 70.0 wt %, or ≤65.0 wt %, or ≤60.0 wt %, or ≤55.0 wt %, or ≤50.0 wt % of component a, based on the weight of the composition.

Q2] The process of any one of A]-P2] above, wherein the composition comprises ≥0.20 wt %, or ≥0.30 wt %, or ≥0.40 wt %, or ≥0.50 wt % of component b, based on the weight of the composition.

R2] The process of any one of A]-Q2] above, wherein the composition comprises ≤5.00 wt %, or 4.00 wt %, or 3.00 wt %, or 2.00 wt %, or ≤1.80 wt %, or ≤1.60 wt %, or 1.40 wt %, or ≤1.30 wt %, or ≤1.20 wt % of component b, based on the weight of the composition.

S2] The process of any one of A]-R2] above, wherein the composition comprises ≥0.10 wt %, or ≥0.20 wt %, or ≥0.25 wt %, or ≥0.30 wt %, or ≥0.35 wt %, or ≥0.40 wt %, or ≥0.45 wt % of component c, based on the weight of the composition.

T2] The process of any one of A]-S2] above, wherein the composition comprises ≤5.00 wt %, ≤3.00 wt %, or ≤2.50 wt %, or 2.00 wt %, or ≤1.50 wt %, or ≤1.00 wt %, ≤0.80 wt %, or 0.75 wt %, or ≤0.70 wt %, or ≤0.65 wt %, or ≤0.60 wt %, or 0.55 wt % of component c, based on the weight of the composition.

U2] The process of any one of A]-T2] above, wherein the composition comprises ≥20.0 wt %, ≥30.0 wt %, ≥40.0 wt %, or ≥50.0 wt %, or ≥60.0 wt %, or ≥70.0 wt %, or ≥80.0 wt %, or ≥90.0 wt %, or ≥95.0 wt %, or ≥98.0 wt %, or ≥98.2 wt %, or ≥98.4 wt %, or ≥98.6 wt %, or ≥98.8 wt %, or ≥99.0 wt % the sum of components a and b, based on the weight of the composition.

V2] The process of any one of A]-U2] above, wherein the composition comprises ≤100.0 wt %, or ≤99.0 wt %, or 99.8 wt %, or ≤99.6 wt %, or ≤99.4 wt %, or ≤99.0 wt %, or 95.0 wt %, or ≤90.0 wt %, or ≤85.0 wt %, or ≤80.0 wt %, or ≤75.0 wt %, or ≤70.0 wt %, or ≤65.0 wt %, or ≤60.0 wt %, or ≤55.0 wt %, or ≤50.0 wt % of the sum of components a and b, based on the weight of the composition.

W2] The process of any one of A]-V2] above, wherein the composition comprises ≥20.0 wt %, ≥30.0 wt %, ≥40.0 wt %, or ≥50.0 wt %, or ≥60.0 wt %, or ≥70.0 wt %, or ≥80.0 wt %, or ≥90.0 wt %, or ≥95.0 wt %, or ≥98.0 wt %, or ≥99.0 wt %, or ≥99.0 wt %, or ≥99.2 wt %, or ≥99.3 wt %, or ≥99.4 wt % of the sum of components a, b and c, based on the weight of the composition.

X2] The process of any one of A]-W2] above, wherein the composition comprises ≤100.0 wt %, or ≤99.9 wt %, or ≤99.8 wt %, or ≤99.7 wt %, or ≤99.6 wt %, or ≤99.0 wt %, or ≤95.0 wt %, or ≤90.0 wt %, or ≤85.0 wt %, or ≤80.0 wt %, or ≤75.0 wt %, or ≤70.0 wt %, or 65.0 wt %, or ≤60.0 wt %, or ≤55.0 wt %, or ≤50.0 wt % of the sum of components a, b and c, based on the weight of the composition.

Y2] The process of any one of A]-X2] above, wherein the composition is thermally treated at a temperature ≥120° C., or ≥125° C., or ≥130° C., or ≥135° C., or ≥140° C., or ≥145° C., or ≥150° C.

Z2] The process of any one of A]-Y2] above, wherein the composition is thermally treated at a temperature ≤200° C., or ≤195° C., or ≤190° C., or ≤185° C., or ≤180° C.

A3] The process of any one of A]-Z2] above, wherein the composition, after thermal treatment at a temperature from 150° C. to 200° C., for 15 to 30 minutes, has a “MH-ML” value ≥2.6, or ≥2.8, or ≥3.0, or ≥3.5, or ≥4.0, or ≥4.5, or ≥5.0, or ≥5.5, or ≥6.0, or ≥6.5, or ≥7.0, or ≥7.5, or ≥8.0, or ≥9.0, or ≥10.0, or ≥10.5. Units=dN*m. The MH value and the ML value are determined by MDR as described herein.

B3] The process of any one of A]-A3] above, wherein the composition, after thermal treatment at a temperature from 150° C. to 200° C., for 15 to 30 minutes, has a “MH-ML” value ≤50.0, or ≤45.0, or ≤40.0, or ≤35.0, or ≤30.0, or ≤25.0, or ≤20.0, or ≤15.0, or ≤14.0, or ≤13.0, or ≤12.0, or ≤11.0, or ≤10.5, or ≤10.0, or ≤9.5, or ≤9.0, or ≤8.5, or 8.0. Units=dN*m.

C3] The process of any one of A]-B3] above, wherein the composition, after thermal treatment at a temperature from 150° C. to 200° C., for 15 to 30 minutes, has a [(MH-ML)/T90] value ≥0.60 dN*m/min, or ≥0.70 dN*m/min, or ≥0.80 dN*m/min, or ≥0.90 dN*m/min, or ≥0.92 dN*m/min, or ≥0.94 dN*m/min, or ≥0.96 dN*m/min, or ≥0.98 dN*m/min, or ≥1.00 dN*m/min, or ≥1.50 dN*m/min, or ≥2.00 dN*m/min, or ≥3.00 dN*m/min. The MH, ML and T90 values are determined by MDR as described herein.

D3] The process of any one of A]-C3] above, wherein the composition, after thermal treatment at a temperature from 150° C. to 200° C., for 15 to 30 minutes, has a [(MH-ML)/T90] value ≤20 dN*m/min, or ≤18 dN*m/min, or ≤16 dN*m/min, or ≤14 dN*m/min, or ≤12 dN*m/min, or ≤10 dN*m/min, or ≤8.0 dN*m/min, or ≤6.0 dN*m/min, or ≤4.0 dN*m/min.

E3] The process of any one of A]-D3] above, wherein the composition further comprises a thermoplastic polymer, different from the interpolymer of component a in one or more features, such as monomer(s) types and/or amounts, density, melt index (I2), Mn, Mw, MWD, or any combination thereof, and further, in one or more features, such as monomer(s) types and/or amounts, Mn, Mw, MWD, or any combination thereof.

F3] The process of any one of A]-E3] above, wherein the composition further comprises an ethylene/alpha-olefin interpolymer, and further an ethylene/alpha-olefin copolymer.

G3] The process of F3] above, wherein the alpha-olefin of the ethylene/alpha-olefin interpolymer, and further copolymer, is a C3-C20 alpha-olefin, further a C3-C10 alpha-olefin, further a C3-C8 alpha-olefin, further propylene, 1-butene, 1-hexene or 1-octene, further propylene, 1-butene, or 1-octene, further 1-butene or 1-octene, further 1-octene.

H3] The process of any one of A]-G3] above, wherein the olefin/silane interpolymer of component a has a melting temperature (Tₘ) ≥0° C., ≥5° C., ≥10° C., ≥15° C., ≥20° C., or ≥25° C., or ≥30° C., or ≥35° C.

I3] The process of any one of A]-H3] above, wherein the olefin/silane interpolymer of component a has a melting temperature (Tₘ)≤100° C., or ≤90° C., or ≤85° C., or ≤80° C., or ≤75° C., or ≤70° C., or ≤65° C.

J3] The process of any one of A]-I3] above, wherein the composition further comprises a filler and/or an oil.

K3] The process of any one of A]-J3] above, wherein the composition comprises ≤100 ppm, or ≤50 ppm, or ≤20 ppm, or ≤10 ppm, or ≤5.0 ppm of a Lewis acid (for example, a sulfonic acid), based on the weight of the composition.

L3] The process of any one of A]-K3] above, wherein the composition does not comprise a Lewis acid.

M3] The process of any one of A]-L3] above, wherein the composition comprises ≤100 ppm, or ≤50 ppm, or ≤20 ppm, or ≤10 ppm, or ≤5.0 ppm of a Lewis base, based on the weight of the composition.

N3] The process of any one of A]-M3] above, wherein the composition does not comprise a Lewis base.

O3] A crosslinked composition formed by the process of any one of A]-N3] above.

P3] An article comprising at least one component formed from the composition of 03] above.

Q3] The article of P3] above, wherein the article is a film.

R3] The article of P3] above, wherein the article is a solar cell module, a cable, a footwear component, an automotive part, a window profile, a tire, a tube, or a roofing membrane.

S3] A composition that comprises the following components:
a) at least one olefin/silane interpolymer comprising at least one (type) Si—H group,
b) at least one peroxide, and
c) optionally, at least one crosslinking coagent.

T3] The composition of S3] above, wherein the olefin/silane interpolymer of component a is an ethylene/alpha-olefin/silane interpolymer, and further an ethylene/alpha-olefin/silane terpolymer.

U3] The composition of T3] above, wherein the alpha-olefin of the olefin/silane interpolymer, and further terpolymer, is a C3-C20 alpha-olefin, further a C3-C10 alpha-olefin, further a C3-C8 alpha-olefin, further propylene, 1-butene, 1-hexene or 1-octene, further propylene, 1-butene, or 1-octene, further 1-butene or 1-octene, further 1-octene.

V3] The composition of any one of S3]-U3] above, wherein the interpolymer of component a comprises, in polymerized form, ≥0.10 wt %, or ≥0.20 wt %, or ≥0.30 wt %, or ≥0.40 wt %, or ≥0.50 wt %, or ≥0.60 wt %, or ≥0.70 wt %, or ≥0.80 wt %, or ≥0.90 wt %, or ≥1.0 wt % of the silane, based on the weight of the interpolymer.

W3] The composition of any one of S3]-V3] above, wherein the interpolymer of component a comprises, in polymerized form, ≤40 wt %, or ≤30 wt %, or ≤20 wt %, or ≤10 wt %, or ≤8.0 wt %, or ≤6.0 wt %, or ≤4.0 wt % of the silane, based on the weight of the interpolymer.

X3] The composition of any one of S3]-W3] above, wherein the interpolymer of component a comprises, in polymerized form, ≤5.0 wt %, or ≤4.5 wt %, or ≤4.0 wt %, or ≤3.8 wt %, or ≤3.6 wt %, or ≤3.4 wt %, or ≤3.2 wt %, or 3.0 wt % of the silane, based on the weight of the interpolymer.

Y3] The composition of any one of S3]-X3] above, wherein the interpolymer of component a has a molecular weight distribution (MWD=Mw/Mn) ≥1.5, or ≥1.6, or ≥1.7, or ≥1.8, or ≥1.9.

Z3] The composition of any one of S3]-Y3] above, wherein the interpolymer of component a has a molecular weight distribution MWD ≤5.0, or ≤4.5, or ≤4.0, or ≤3.5, or ≤3.0, or ≤2.9, or ≤2.8, or ≤2.7, or ≤2.6, or ≤2.5, or ≤2.4, or ≤2.3.

A4] The composition of any one of S3]-Z3] above, wherein the interpolymer of component a has a number average molecular weight (Mn) ≥10,000 g/mol, or ≥12,000 g/mol, or ≥14,000 g/mol, or ≥16,000 g/mol, or ≥18,000 g/mol, or ≥20,000 g/mol, or ≥22,000 g/mol, or ≥24,000 g/mol ≥26,000 g/mol, or ≥28,000 g/mol, or ≥30,000 g/mol, or ≥32,000 g/mol.

B4] The composition of any one of S3]-A4] above, wherein the interpolymer of component a has a number average molecular weight (Mn)≤100,000 g/mol, or ≤95,000 g/mol, or ≤90,000 g/mol, or ≤85,000 g/mol, or ≤80,000 g/mol, or ≤75,000 g/mol, or ≤70,000 g/mol, or ≤68,000 g/mol, or ≤66,000 g/mol, or ≤64,000 g/mol, or ≤62,000 g/mol, or ≤60,000 g/mol.

C4] The composition of any one of S3]-B4] above, wherein the interpolymer of component a has a weight average molecular weight (Mw) ≥20,000 g/mol, or ≥25,000 g/mol, or ≥30,000 g/mol, or ≥35,000 g/mol, or ≥40,000 g/mol, or ≥45,000 g/mol, or ≥50,000 g/mol, or ≥52,000 g/mol, or ≥54,000 g/mol, or ≥56,000 g/mol, or ≥58,000 g/mol, or ≥60,000 g/mol, or ≥62,000 g/mol.

D4] The composition of any one of S3]-C4] above, wherein the interpolymer of component a has a weight average molecular weight (Mw)≤300,000 g/mol, or ≤250,000 g/mol, or ≤200,000 g/mol, or ≤190,000 g/mol, or ≤180,000 g/mol, or ≤170,000 g/mol, or ≤160,000 g/mol, or ≤150,000 g/mol, or ≤148,000 g/mol, or ≤146,000 g/mol, or ≤144,000 g/mol, or ≤142,000 g/mol, or ≤140,000 g/mol, or ≤138,000 g/mol.

E4] The composition of any one of S3]-D4] above, wherein the interpolymer of component a has a density ≥0.855 g/cc, or ≥0.856 g/cc, or ≥0.857 g/cc, or ≥0.858 g/cc, or ≥0.859 g/cc, or ≥0.860 g/cc, or ≥0.861 g/cc, or ≥0.862 g/cc, or ≥0.863 g/cc, or ≥0.864 g/cc, or ≥0.865 g/cc, or ≥0.866 g/cc, or ≥0.867 g/cc (1 cc=1 cm³).

F4] The composition of any one of S3]-E4] above, wherein the interpolymer of component a has a density ≤0.950 g/cc, or ≤0.920 g/cc, or ≤0.900 g/cc, or ≤0.890 g/cc, or ≤0.888 g/cc, or ≤0.886 g/cc, or ≤0.884 g/cc, or ≤0.882 g/cc, or ≤0.880 g/cc, or ≤0.878 g/cc, or ≤0.876 g/cc, or ≤0.874 g/cc.

G4] The composition of any one of S3]-F4] above, wherein the interpolymer of component a has a melt index (I2) ≥0.5 dg/min, or ≥1.0 dg/min, or ≥2.0 dg/min, or ≥5.0 dg/min, or ≥10 dg/min.

H4] The composition of any one of S3]-G4] above, wherein the interpolymer of component a has a melt index (I2)≤1,000 dg/min, or ≤500 dg/min, or ≤250 dg/min, or ≤100 dg/min, or ≤50 dg/min, or ≤20 dg/min.

I4] The composition of any one of S3]-H4] above, wherein the interpolymer of component a has an I10/I2 ratio ≥6.0, or ≥7.0, or ≥8.0, or ≥9.0, or ≥10.

J4] The composition of any one of S3]-I4] above, wherein the interpolymer of component a has an 110/I2 ratio ≤30, or ≤25, or ≤20, or ≤15, or ≤12.

K4] The composition of any one of S3]-J4] above, wherein silane is derived from a silane monomer selected from Formula 1, as described above.

L4] The composition of K4] above, wherein, for Formula 1, x is from 0 to 10, or from 0 to 8, or from 0 to 6, or from 0 to 4, or from 0 to 2, or 0 or 1, or 0.

M4] The interpolymer of K4] or L4] above, wherein, for Formula 1, A is a C2-C50 alkenyl group, and further a C2-C40 alkenyl group, further a C2-C30 alkenyl group, further a C2-C20 alkenyl group.

N4] The composition of any one of K4]-M4] above, wherein, for Formula 1, A is selected from the following structures i)-iv):
i) R¹R²C═CR³—, as described above;
ii) R¹R²C═CR³—(CR⁴R⁵)ₙ—, as described above;

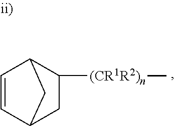

as described above; or

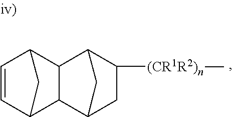

as described above.

O4] The interpolymer of any one of K4]-N4] above, wherein, for Formula 1, A is selected from the following structures i)-iv):
i) H₂C═CH—;
ii) H₂C═CH—(CH₂)ₙ—, as described above;

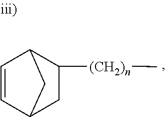

as described above; or

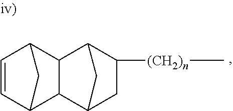

as described above.

P4] The composition of any one of K4]-04] above, wherein, for Formula 1, B is an alkyl, further a C1-C5 alkyl, further a C1-C4 alkyl, further a C1-C3 alkyl, further a C1-C2 alkyl, further methyl.

Q4] The composition of any one of K4]-P4] above, wherein, for Formula 1, C is an alkyl, further a C1-C5 alkyl, further a C1-C4 alkyl, further a C1-C3 alkyl, further a C1-C2 alkyl, further methyl.

R4] The composition of any one of K4]-Q4] above, wherein, for Formula 1, E is an alkyl, further a C1-C5 alkyl, further a C1-C4 alkyl, further a C1-C3 alkyl, further a C1-C2 alkyl, further methyl.

S4] The composition of any one of K4]-R4] above, wherein, for Formula 1, F is an alkyl, further a C1-C5 alkyl, further a C1-C4 alkyl, further a C1-C3 alkyl, further a C1-C2 alkyl, further methyl.

T4] The composition of any one of K4]-S4] above, wherein Formula 1 is selected from compounds s1) through s16), as described above.

U4] The composition of any one of K4]-T4] above, wherein Formula 1 is selected from structures s1) to s8), as described above.

V4] The composition of any one of K4]-T4] above, wherein Formula 1 is selected from structures s9) to s16), as described above.

W4] The composition of any one of S3]-V4] above, wherein the silane is derived from a silane monomer selected from the following compounds: allyldimethylsilane, 3-butenyl-dimethylsilane, 1-(but-3-en-1-yl)-1,1,3,3-tetramethyl-disiloxane (BuMMH), 1-(hex-5-en-1-yl)-1,1,3,3-tetramethyldisiloxane (HexMMH), (2-bicyclo-[2.2.1]hept-5-en-2-yl)ethyl)dimethylsilane (NorDMS) or 1-(2-bicyclo[2.2.1]hept-5-en-2-yl)ethyl)-1,1,3,3-tetra-methyldisiloxane (NorMMH), or any combination thereof.

X4] The composition of any one of S3]-W4] above, wherein the composition has a weight ratio of component a to component b ≥20, or ≥25, or ≥30, or ≥35, or ≥40, or ≥45 or ≥50, or ≥55, or 60, or 65, or ≥70, or ≥75, or 80.

Y4] The composition of any one of S3]-X4] above, wherein the composition has a weight ratio component a to component b≤450, or ≤400 or ≤350, or ≤300, or ≤250, or ≤245, or ≤240, or ≤230, or ≤220, or ≤210 or ≤200, or ≤195, or ≤190, or ≤185.

Z4] The composition of any one of S3]-Y4] above, wherein the composition comprises component c (at least one crosslinking coagent).

A5] The composition of Z4] above, wherein the composition has a weight ratio component b to component c ≥0.80, or ≥0.85, or ≥0.90, or ≥0.95, or ≥1.00.

B5] The composition of Z4] or A5] above, wherein the composition has a weight ratio component b to component c≤3.00, or ≤2.80, or ≤2.60, or ≤2.50, or ≤2.40.

C5] The composition of any one of S3]-B5] above, wherein the composition has a mole ratio of “the active oxygen atom in component b” to component a ≥0.5, or ≥0.7, or ≥1.0, or ≥1.5, or ≥2.0, or ≥2.5, or ≥3.0, or ≥3.5, or ≥4.0, or ≥5.0, or ≥6.0, or ≥7.0, or ≥8.0, or ≥8.5, or ≥10.0, or ≥20, or ≥25, or ≥26.

D5] The composition of any one of S3]-C5] above, wherein the composition has a mole ratio of “the active oxygen atom in component b” to component a≤50, a≤30, or ≤25, or ≤20, or ≤15, or ≤12, or ≤10, or ≤9.5, or ≤9, or ≤7.5, or ≤5.5.

E5] The composition of any one of Z4]-D5] above, wherein the composition has a mole ratio component c to “the active oxygen atom in component b” ≥0, or ≥0.01, or ≥0.05, or ≥0.10, or ≥0.15, or ≥0.20.

F5] The composition of any one of Z4]-E5] above, wherein the composition has a mole ratio component c to “the active oxygen atom in component b”≤10.00, or ≤7.50, or ≤5.00, or ≤2.50, or ≤1.00, or ≤0.75, or ≤0.50.

G5] The composition of any one of S3]-F5] above, wherein the composition comprises ≥20.0 wt %, ≥30.0 wt %, ≥40.0 wt %, or ≥45.0 wt %, or ≥50.0 wt %, or ≥55.0 wt %, or ≥60.0 wt %, or ≥65.0 wt %, or ≥70.0 wt %, or ≥75.0 wt %, or ≥80.0 wt %, or ≥85.0 wt %, or ≥90.0 wt %, or ≥95.0 wt %, or ≥96.0 wt %, or ≥97.0 wt %, or ≥98.0 wt %, or ≥99.0 wt % of component a, based on the weight of the composition.

H5] The composition of any one of S3]-G5] above, wherein the composition comprises ≤99.9 wt %, or ≤99.8 wt %, or ≤99.6 wt %, or ≤99.4 wt %, or ≤99.0 wt %, or ≤95.0 wt %, or ≤90.0 wt %, or ≤85.0 wt %, or ≤80.0 wt %, or ≤75.0 wt %, or ≤70.0 wt %, or ≤65.0 wt %, or ≤60.0 wt %, or ≤55.0 wt %, or ≤50.0 wt % of component a, based on the weight of the composition.

I5] The composition of any one of S3]-H5] above, wherein the composition comprises ≥0.20 wt %, or ≥0.30 wt %, or ≥0.40 wt %, or ≥0.50 wt % of component b, based on the weight of the composition.

J5] The composition of any one of S3]-I5] above, wherein the composition comprises ≤5.00 wt %, or ≤4.00 wt %, or ≤3.00 wt %, or ≤2.00 wt %, or ≤1.80 wt %, or ≤1.60 wt %, or ≤1.40 wt %, or ≤1.30 wt %, or ≤1.20 wt % of component b, based on the weight of the composition.

K5] The composition of any one of S3]-J5] above, wherein the composition comprises ≥0.10 wt %, or ≥0.20 wt %, or ≥0.25 wt %, or ≥0.30 wt %, or ≥0.35 wt %, or ≥0.40 wt %, or ≥0.45 wt % of component c, based on the weight of the composition.

L5] The composition of any one of S3]-K5] above, wherein the composition comprises ≤3.00 wt %, or ≤2.50 wt %, or ≤2.00 wt %, or ≤1.50 wt %, or ≤1.00 wt %, ≤0.80 wt %, or ≤0.75 wt %, or ≤0.70 wt %, or ≤0.65 wt %, or ≤0.60 wt %, or ≤0.55 wt % of component c, based on the weight of the composition.

M5] The composition of any one of S3]-L5] above, wherein the composition comprises ≥20.0 wt %, ≥30.0 wt %, ≥40.0 wt %, or ≥50.0 wt %, or ≥60.0 wt %, or ≥70.0 wt %, or ≥80.0 wt %, or ≥90.0 wt %, or ≥95.0 wt %, or ≥98.0 wt %, or ≥98.2 wt %, or ≥98.4 wt %, or ≥98.6 wt %, or ≥98.8 wt %, or ≥99.0 wt % the sum of components a and b, based on the weight of the composition.

N5] The composition of any one of S3]-M5] above, wherein the composition comprises ≤100.0 wt %, or 99.0 wt %, or ≤99.8 wt %, or 99.6 wt %, or ≤99.4 wt %, or ≤99.0 wt %, or ≤95.0 wt %, or ≤90.0 wt %, or ≤85.0 wt %, or ≤80.0 wt %, or 75.0 wt %, or ≤70.0 wt %, or ≤65.0 wt %, or ≤60.0 wt %, or ≤55.0 wt %, or ≤50.0 wt % of the sum of components a and b, based on the weight of the composition.

O5] The composition of any one of S3]-N5] above, wherein the composition comprises ≥20.0 wt %, ≥30.0 wt %, ≥40.0 wt %, or ≥50.0 wt %, or ≥60.0 wt %, or ≥70.0 wt %, or ≥80.0 wt %, or ≥90.0 wt %, or ≥95.0 wt %, or ≥98.0 wt %, or ≥99.0 wt %, or ≥99.0 wt %, or ≥99.2 wt %, or ≥99.3 wt %, or ≥99.4 wt % of the sum of components a, b and c, based on the weight of the composition.

P5] The composition of any one of S3]-05] above, wherein the composition comprises ≤100.0 wt %, or ≤99.9 wt %, or ≤99.8 wt %, or ≤99.7 wt %, or ≤99.6 wt %, or ≤99.0 wt %, or ≤95.0 wt %, or ≤90.0 wt %, or ≤85.0 wt %, or ≤80.0 wt %, or ≤75.0 wt %, or ≤70.0 wt %, or ≤65.0 wt %, or ≤60.0 wt %, or ≤55.0 wt %, or ≤50.0 wt % of the sum of components a, b and c, based on the weight of the composition.

Q5] The composition of any one of S3]-P5] above, wherein the composition, after thermal treatment at a temperature from 150° C. to 200° C., for 15 to 30 minutes, has a “MH-ML” value ≥2.6, or ≥2.8, or ≥3.0, or ≥3.5, or ≥4.0, or ≥4.5, or ≥5.0, or ≥5.5, or ≥6.0, or ≥6.5, or ≥7.0, or ≥7.5, or ≥8.0, or ≥9.0, or ≥10.0. Units=dN*m. The MH value and the ML value are determined by MDR as described herein.

R⁵] The composition of any one of S3]-Q5] above, wherein the composition, after thermal treatment at a temperature from 150° C. to 200° C., for 15 to 30 minutes, has a “MH-ML” value ≤50.0, or ≤45.0, or ≤40.0, or ≤35.0, or ≤30.0, or ≤25.0, or ≤20.0, or ≤15.0, or ≤14.0, or ≤13.0, or ≤12.0, or ≤11.0, or ≤10.5, or ≤10.0, or ≤9.5, or ≤9.0, or ≤8.5, or 8.0. Units=dN*m.

S5] The composition of any one of S3]-R⁵] above, wherein the composition, after thermal treatment at a temperature from 150° C. to 200° C., for 15 to 30 minutes, has a [(MH-ML)/T90] value ≥0.60 dN*m/min, or ≥0.70 dN*m/min, or ≥0.80 dN*m/min, or ≥0.90 dN*m/min, or ≥0.92 dN*m/min, or ≥0.94 dN*m/min, or ≥0.96 dN*m/min, or ≥0.98 dN*m/min, or ≥1.00 dN*m/min, or ≥1.50 dN*m/min, or ≥2.00 dN*m/min, or ≥3.00 dN*m/min. The MH, ML and T90 values are determined by MDR as described herein.

T5] The composition of any one of S3]-S5] above, wherein the composition, after thermal treatment at a temperature from 150° C. to 200° C., for 15 to 30 minutes, has a [(MH-ML)/T90] value ≤20 dN*m/min, or ≤18 dN*m/min, or ≤16 dN*m/min, or ≤14 dN*m/min, or ≤12 dN*m/min, or ≤10 dN*m/min, or ≤8.0 dN*m/min, or ≤6.0 dN*m/min, or ≤4.0 dN*m/min.

U5] The composition of any one of S3]-T5] above, wherein the composition further comprises a thermoplastic polymer, different from the interpolymer of component a in one or more features, such as monomer(s) types and/or amounts, density, melt index (I2), Mn, Mw, MWD, or any combination thereof, and further, in one or more features, such as monomer(s) types and/or amounts, Mn, Mw, MWD, or any combination thereof.

V5] The composition of any one of S3]-U5] above, wherein the composition further comprises an ethylene/alpha-olefin interpolymer, and further an ethylene/alpha-olefin copolymer.

W5] The composition of V5] above, wherein the alpha-olefin of the ethylene/alpha-olefin interpolymer, and further a copolymer, is a C3-C20 alpha-olefin, further a C3-C10 alpha-olefin, further a C3-C8 alpha-olefin, further propylene, 1-butene, 1-hexene or 1-octene, further propylene, 1-butene, or 1-octene, further 1-butene or 1-octene, further 1-octene.

X5] The composition of any one of S3]-W5] above, wherein the olefin/silane interpolymer of component a has a melting temperature (Tₘ) 0° C., 5° C., 10° C., 15° C., 20° C., or 25° C., or ≥30° C., or ≥35° C.

Y5] The composition of any one of S3]-X5] above, wherein the olefin/silane interpolymer of component a has a melting temperature (Tₘ)≤100° C., or ≤90° C., or ≤85° C., or ≤80° C., or S 75° C., or ≤70° C., or ≤65° C.

Z5] The composition of any one of S3]-Y5] above, wherein the composition further comprises a filler and/or an oil.

A6] The composition of any one of S3]-Z5] above, wherein the composition comprises ≤100 ppm, or ≤50 ppm, or 20 ppm, or ≤10 ppm, or ≤5.0 ppm of a Lewis acid (for example, a sulfonic acid), based on the weight of the composition.

B6] The composition of any one of S3]-A6] above, wherein the composition does not comprise a Lewis acid.

C6] The composition of any one of S3]-B6] above, wherein the composition comprises ≤100 ppm, or ≤50 ppm, or 20 ppm, or ≤10 ppm, or ≤5.0 ppm of a Lewis base, based on the weight of the composition.

D6] The composition of any one of S3]-C6] above, wherein the composition does not comprise a Lewis base.

E6] A crosslinked composition formed the composition of any one of S3]-D6] above.

F6] An article comprising at least one component formed from the composition of any one of S3]-E6] above.

G6] The article of F6] above, wherein the article is a film.

H6] The article of F6] above, wherein the article is a solar cell module, a cable, a footwear component, an automotive part, a window profile, a tire, a tube/hose, or a roofing membrane.

I6] The process of any one of A]-N3] above, wherein the composition, after thermal treatment at a temperature from 150° C. to 200° C., for 15 to 30 minutes, has a compression set of ≥1%, or ≥2%, or ≥3%, or ≥4%, or ≥5%.

J6] The process of any one of A]-N3] or 16] above, wherein the composition, after thermal treatment at a temperature from 150° C. to 200° C., for 15 to 30 minutes, has a compression set of ≤50%, or ≤40%, or ≤30%, or ≤20%, or ≤15%, or ≤10%, or ≤8%, or ≤6.5%.

K6] The process of any one of A]-N3], I6], or J6] above, wherein the composition, after thermal treatment at a temperature from 150° C. to 200° C., for 15 to 30 minutes, has a 300% modulus of ≥1 MPa, or ≥2 MPa, or ≥3 MPa, or ≥4 MPa, or ≥4.7 MPa, or ≥4.8 MPa, or ≥5.0 MPa.

L6] The process of any one of A]-N3] or I6]-K6] above, wherein the composition, after thermal treatment at a temperature from 150° C. to 200° C., for 15 to 30 minutes, has a 300% modulus of ≤20 MPa, or ≤15 MPa, or ≤10 MPa, or ≤8 MPa, or ≤6 MPa, or ≤5.8 MPa.

M6] The composition of any one of S3]-D6] above, wherein the composition, after thermal treatment at a temperature from 150° C. to 200° C., for 15 to 30 minutes, has a compression set of ≥1%, or ≥2%, or ≥3%, or ≥4%, or ≥5%.

N6] The composition of any one of S3]-D6] or M6] above, wherein the composition, after thermal treatment at a temperature from 150° C. to 200° C., for 15 to 30 minutes, has a compression set of ≤50%, or ≤40%, or ≤30%, or ≤20%, or ≤15%, or ≤10%, or ≤8%, or ≤6.5%.

O6] The composition of any one of S3]-D6], M6], or N6] above, wherein the composition, after thermal treatment at a temperature from 150° C. to 200° C., for 15 to 30 minutes, has a 300% modulus of ≥1 MPa, or ≥2 MPa, or ≥3 MPa, or ≥4 MPa, or ≥4.7 MPa, or ≥4.8 MPa, or ≥5.0 MPa.

P6] The composition of any one of S3]-D6] or M6]-06] above, wherein the composition, after thermal treatment at a temperature from 150° C. to 200° C., for 15 to 30 minutes, has a 300% modulus of ≤20 MPa, or ≤15 MPa, or 10 MPa, or 8 MPa, or 6 MPa, or 5.8 MPa.

Q6] A crosslinked composition formed by the process of any one of I6]-L6] or by the composition of any one of M6]-P6].

R6] An article comprising at least one component formed from the composition of Q6].

S6] The article of R6] above, wherein the article is a film.

T6] The article of R6] above, wherein the article is a solar cell module, a cable, a footwear component, an automotive part, a window profile, a tire, a tube, or a roofing membrane.

### TEST METHODS

### Gel Permeation Chromatography

The chromatographic system consisted of a PolymerChar GPC-IR (Valencia, Spain) high temperature GPC chromatograph, equipped with an internal IR5 infra-red detector (IR5). The autosampler oven compartment was set at 1600 Celsius, and the column compartment was set at 1500 Celsius. The columns were four AGILENT “Mixed A” 30 cm, 20-micron linear mixed-bed columns. The chromatographic solvent was 1,2,4-trichloro-benzene, which contained 200 ppm of butylated hydroxytoluene (BHT). The solvent source was nitrogen sparged. The injection volume used was 200 microliters, and the flow rate was 1.0 milliliters/minute.

Calibration of the GPC column set was performed with 21 narrow molecular weight distribution polystyrene standards, with molecular weights ranging from 580 to 8,400,000, and which were arranged in six “cocktail” mixtures, with at least a decade of separation between individual molecular weights. The standards were purchased from Agilent Technologies. The polystyrene standards were prepared at “0.025 grams in 50 milliliters” of solvent, for molecular weights equal to, or greater than, 1,000,000, and at “0.05 grams in 50 milliliters” of solvent, for molecular weights less than 1,000,000. The polystyrene standards were dissolved at 80 degrees Celsius, with gentle agitation, for 30 minutes. The polystyrene standard peak molecular weights were converted to polyethylene molecular weights using Equation 1 (as described in Williams and Ward, J. Polym. Sci., Polym. Let., 6, 621 (1968)):

M_{polyethylene}=A×(M_{polystyrene})^{B} (EQ1),

where M is the molecular weight, A has a value of 0.4315 and B is equal to 1.0.

A fifth order polynomial was used to fit the respective polyethylene-equivalent calibration points. A small adjustment to A (from approximately 0.375 to 0.445) was made to correct for column resolution and band-broadening effects, such that linear homopolymer polyethylene standard is obtained at 120,000 Mw. The total plate count of the GPC column set was performed with decane (prepared at “0.04 g in 50 milliliters” of TCB, and dissolved for 20 minutes with gentle agitation.) The plate count (Equation 2) and symmetry (Equation 3) were measured on a 200 microliter injection according to the following equations:

$$Plate Count = 5.54 * {( \frac{( {RV}_{Peak Max}}{Peak Width at \frac{1}{2} height} )}^{2} , \qquad ( EQ 2 )$$

where RV is the retention volume in milliliters, the peak width is in milliliters, the peak max is the maximum height of the peak, and ½ height is ½ height of the peak maximum; and

$$Symmetry = \frac{( Rear Peak {RV}_{one tenth height} - R {V}_{Peak max} )}{( R {V}_{Peak max} - Front Peak {RV}_{one tenth height} )} , \qquad ( EQ 3 )$$

where RV is the retention volume in milliliters, and the peak width is in milliliters, Peak max is the maximum position of the peak, one tenth height is 1/10 height of the peak maximum, and where rear peak refers to the peak tail at later retention volumes than the peak max, and where front peak refers to the peak front at earlier retention volumes than the peak max. The plate count for the chromatographic system should be greater than 18,000, and symmetry should be between 0.98 and 1.22.

Samples were prepared in a semi-automatic manner with the PolymerChar “Instrument Control” Software, wherein the samples were weight-targeted at 2 mg/ml, and the solvent (contained 200 ppm BHT) was added to a pre nitrogen-sparged, septa-capped vial, via the PolymerChar high temperature autosampler. The samples were dissolved for two hours at 160° Celsius under “low speed” shaking.

The calculations of Mn_{(GPC)}, Mw_{(GPC)}, and Mz_{(GPC)} were based on GPC results using the internal IR5 detector (measurement channel) of the PolymerChar GPC-IR chromatograph according to Equations 4-6, using PolymerChar GPCOne™ software, the baseline-subtracted IR chromatogram at each equally-spaced data collection point (i), and the polyethylene equivalent molecular weight obtained from the narrow standard calibration curve for the point (i) from Equation 1. Equations 4-6 are as follows:

$${Mn}_{( GPC )} = \frac{{\sum }^{i} {IR}_{i}}{{\sum }^{i} ( {IR}_{i} / {M}_{polyethyle {ne}_{i}} )} , \qquad ( EQ 4 )$$

$${Mw}_{( GPC )} = \frac{{\sum }^{i} ( {IR}_{i} * {M}_{{polyethylene}_{i}} )}{{\sum }^{i} {IR}_{i}} , and \qquad ( EQ 5 )$$

$${Mz}_{( GPC )} = \frac{{\sum }^{i} ( {IR}_{i} * {M}_{{polyethylene}_{i}}^{2} )}{{\sum }^{i} ( {IR}_{i} * {M}_{{polyethylene}_{i}} )} . \qquad ( EQ 6 )$$

In order to monitor the deviations over time, a flowrate marker (decane) was introduced into each sample, via a micropump controlled with the PolymerChar GPC-IR system. This flowrate marker (FM) was used to linearly correct the pump flowrate (Flowrate(nominal)) for each sample, by RV alignment of the respective decane peak within the sample (RV(FM Sample)), to that of the decane peak within the narrow standards calibration (RV(FM Calibrated)). Any changes in the time of the decane marker peak were then assumed to be related to a linear-shift in flowrate (Flowrate(effective)) for the entire run.

To facilitate the highest accuracy of a RV measurement of the flow marker peak, a least-squares fitting routine was used to fit the peak of the flow marker concentration chromatogram to a quadratic equation. The first derivative of the quadratic equation was then used to solve for the true peak position. After calibrating the system, based on a flow marker peak, the effective flowrate (with respect to the narrow standards calibration) was calculated as Equation 7: Flowrate(effective)=Flowrate(nominal)*(RV(FM Calibrated)/RV(FM Sample)) (EQ7). Processing of the flow marker peak was done via the PolymerChar GPCOne™ Software. Acceptable flowrate correction is such that the effective flowrate should be within +/−0.7% of the nominal flowrate.

### Melt Index

The melt index I2 of an ethylene-based polymer is measured in accordance with ASTM D-1238, condition 190° C./2.16 kg (melt index 110 at 190° C./10.0 kg). The I10/I2 was calculated from the ratio of 110 to the I2. The melt flow rate MFR of a propylene-based polymer is measured in accordance with ASTM D-1238, condition 230° C./2.16 kg.

### Density

ASTM D4703 was used to make a polymer plaque for density analysis. ASTM D792, Method B, was used to measure the density of each polymer.

### NMR Characterization of Terpolymers

For ¹³C NMR experiments, samples were dissolved, in 10 mm NMR tubes, in tetrachloroethane-d₂ (with or without 0.025 M Cr(acac)₃). The concentration was approximately 300 mg/2.8 mL. Each tube was then heated in a heating block set at 110° C. The sample tube was repeatedly vortexed and heated to achieve a homogeneous flowing fluid. The ¹³C NMR spectrum was taken on a BRUKER AVANCE 600 MHz spectrometer, equipped with a 10 mm C/H DUAL cryoprobe. The following acquisition parameters were used: 60 seconds relaxation delay, 90 degree pulse of 12.0 μs, 256 scans. The spectrum was centered at 100 ppm, with a spectral width of 250 ppm. All measurements were taken without sample spinning at 110° C. The ¹³C NMR spectrum was referenced to “74.5 ppm” for the resonance peak of the solvent. For a sample with Cr, the data was taken with a “7 seconds relaxation delay” and 1024 scans.

For ¹H NMR experiments, each sample was dissolved, in 8 mm NMR tubes, in tetrachloroethane-d₂ (with or without 0.001 M Cr(acac)₃). The concentration was approximately 100 mg/1.8 mL. Each tube was then heated in a heating block set at 110° C.

The sample tube was repeatedly vortexed and heated to achieve a homogeneous flowing fluid. The ¹H NMR spectrum was taken on a BRUKER AVANCE 600 MHz spectrometer, equipped with a 10 mm C/H DUAL cryoprobe. A standard single pulse ¹H NMR experiment was performed. The following acquisition parameters were used: 70 seconds relaxation delay, 90 degree pulse of 17.2 μs, 32 scans. The spectrum was centered at 1.3 ppm, with a spectral width of 20 ppm. All measurements were taken, without sample spinning, at 110° C. The ¹H NMR spectrum was referenced to “5.99 ppm” for the resonance peak of the solvent (residual protonated tetrachloroethane). For a sample with Cr, the data was taken with a “16 seconds relaxation delay” and 128 scans.

### Moving Die Rheometer (MDR)

The evaluation of the peroxide reaction to the olefin/silane interpolymer was evaluated through Moving Die Rheometer testing (MDR), as follows. Crosslinking characteristics were measured using an Alpha Technologies Moving Die Rheometer (MDR) 2000 E, according to ASTM D5289, with a 0.5 deg arc. For each composition, the MDR was loaded with approximately 4 g of the formulated composition (pancake sample, melt blend or imbibed pellets; see Compounding Procedures below). The MDR was run for 25-30 minutes at 150° C., 15-25 minutes at 180° C., 25 minutes at 192° C., or 30 minutes at 200° C., depending on the peroxide used in the formulation. The “Torque vs Time” profile was generated over the given interval. The following data were used from each MDR run: MH (dN*m), or the maximum torque exerted by the MDR during the testing interval (this usually corresponds to the torque exerted at the final time point of the test interval); ML (dN*m), or the minimum torque exerted by the MDR during the testing interval (this usually corresponds to the torque exerted at the beginning of the test interval); and T90 (time it takes to reach 90% of the MH value).

### Differential Scanning Calorimetry (DSC)

Differential Scanning Calorimetry (DSC) is used to measure Tₘ, T_{c}, T_{g} and crystallinity in ethylene-based (PE) polymer samples and propylene-based (PP) polymer samples. Each sample (0.5 g) was compression molded into a film, at 5000 psi, 190° C., for two minutes. About 5 to 8 mg of film sample was weighed and placed in a DSC pan. The lid was crimped on the pan to ensure a closed atmosphere. Unless otherwise stated, the sample pan was placed in a DSC cell, and then heated, at a rate of 10° C./min, to a temperature of 180° C. for PE (230° C. for PP). The sample was kept at this temperature for three minutes. Then the sample was cooled at a rate of 10° C./min to −90° C. for PE (−60° C. for PP), and kept isothermally at that temperature for three minutes. The sample was next heated at a rate of 10° C./min, until complete melting (second heat). Unless otherwise stated, melting point (Tₘ) and the glass transition temperature (T_{g}) of each polymer were determined from the second heat curve, and the crystallization temperature (T_{c}) was determined from the first cooling curve. The respective peak temperatures for the Tₘ and the T_{c} were recorded. The percent crystallinity can be calculated by dividing the heat of fusion (H_{f}), determined from the second heat curve, by a theoretical heat of fusion of 292 J/g for PE (165 J/g for PP), and multiplying this quantity by 100 (for example, % cryst. =(Hf/292 J/g)×100 (for PE)). In DSC measurements, it is common that multiple Tₘ peaks are observed, and here, the highest temperature peak as the Tₘ of the polymer is recorded.

### Tensile Measurements

The tensile measurements were performed according to ASTM D1708 standards, at a 1 inch/min extension speed on an INSTRON equipment. The tensile bars were prepared by die cutting from a peroxide crosslinked sheet with thickness of ⅛ inch. The sheet was prepared by first compression molding the peroxide formulated blend in a 4 by 4 by ⅛ inch mold at 100° C. for 5 min, and then heated to 180° C. for 10 min to complete the peroxide curing reaction. Several key parameters were used to characterize the tensile properties of the resins: 1.300% modulus—tensile stress used to reach 300% tensile strain in the testing; 2. Elongation at break —the % strain when the sample break during tensile measurements; 3. Tensile strength at break —the stress used to break the sample in tensile measurements. These parameters were averaged by 5 repeated tensile measurements.

### Compression Set Measurements

The compression sets were measured following ASTM method 395, Method B, with following conditions: ˜0.5 inch (t_{original}) thickness disc with 1 inch diameter was press to 0.375 inch thickness and was aged at temperature 100° C. for 20 hrs; after that the sample was released and allowed to sit at room temperature for 30 minutes, and then the thickness was remeasured to be t_{final}. The compression set (C-set) was calculated with following equations: C-set=(t_{original}−t_{final})/(t_{original}−0.375)*100%. The reported C-set was an average from 3 repeated measurements. The peroxide crosslinked disc used in the compression set measurements was prepared by first compression molding the peroxide formulated blend in a 1 inch diameter and 0.5 inch thickness mold at 100° C., and then heated to 180° C. for 20 min to complete the peroxide curing reaction.

### Gel Content Measurements

Lamination: A plaque of each composition, with dimensions 3 cm×3 cm×0.5 mm (thickness) (9 pieces in 1 mold), was prepared by compression molding at 100° C. (2 min. Pre-heating and 2 min. Under a pressure of 10 mpa, each plaque was cured during lamination on a SHUNHONG SH-X-1000 laminator. Each plaque (3 cm×3 cm×0.5 mm) was placed on a PTFE film (0.15 mm thick), which, in turn, was placed on a glass substrate (3 mm thick) within a metal frame (3 cm×3 cm×0.5 mm) (9 pieces in 1 mold), and another PTFE film (0.15 mm thick) was placed on top of the plaque. Lamination was conducted at 150° C. using a two-step method as follows: 1) a four minute of preheat (at 150° C.) under vacuum without pressure; and 2) a cure for 6 to 12 minutes, at 150° C., with 1 bar pressure. Thus, the total lamination time was 8 (4+4) minutes, 10 (4+6) minutes and 12 (4+8) minutes. The laminated samples were used for the gel test. The wt % gel content is based on the weight of the composition.

The cured plaque prepared from lamination process is cut into small pieces, 3 mm*3 mm. Then around 0.5 g sample (Wₛ) is sealed in a metal mesh (mesh number is 120) and weight (Wₜ₁), the packed sample is put into a 250 ml glass bottle containing 100 ml xylene for 24 h. Then, transfer packed sample into 500 ml flask equipped with condenser and containing 350 ml xylene. After reflux for 5 h, the packed samples are removed from xylene and put into vacuum oven and heating at 120° C. for 2 h under vacuum condition. Take out the sample and get the weight (Wₜ₂). The gel content is calculated by the equation, Gel content=(Wₜ₂−Wₜ₁)/Wₛ*100%.

### EXPERIMENTAL

### Polymer Syntheses and Properties

The ethylene/octene/silane co-polymerizations to produce SiH—POE A, SiH—POE B, SiH—POE C, POE A, and POE C were conducted in a batch reactor designed for ethylene homo-polymerizations and co-polymerizations. The reactor was equipped with electrical heating bands, and an internal cooling coil containing chilled glycol. Both the reactor and the heating/cooling system were controlled and monitored by a process computer. The bottom of the reactor was fitted with a dump valve, which emptied the reactor contents into a dump pot that was vented to the atmosphere. All chemicals used for polymer-ization and the catalyst solutions were run through purification columns prior to use. The ISOPAR-E, 1-octene, ethylene, and silane monomers were also passed through columns. Ultra-high purity grade nitrogen (Airgas) and hydrogen (Airgas) were used. The catalyst cocktail was prepared by mixing, in an inert glove box, the scavenger (MMAO), activator (bis(hydrogenated tallow alkyl)methyl tetrakis(pentafluoro-phenyl)borate(1<->)amine), and catalyst with the appropriate amount of toluene, to achieve a desired molarity solution. The solution was then diluted with ISOPAR-E or toluene to achieve the desired quantity for the polymerization, and drawn into a syringe for transfer to a catalyst shot tank.

In a typical polymerization, the reactor was loaded with ISOPAR-E, and 1-octene via independent flow meters. The silane monomer was then added via a shot tank piped in through an adjacent glove box. After the solvent/comonomer addition, hydrogen (if desired) was added, while the reactor was heated to a polymerization setpoint of 120° C. The ethylene was then added to the reactor via a flow meter, at the desired reaction temperature, to maintain a predetermined reaction pressure set point. The catalyst solution was transferred into the shot tank, via syringe, and then added to the reactor via a high pressure nitrogen stream, after the reactor pressure set point was achieved. A run timer was started upon catalyst injection, after which, an exotherm was observed, as well as a decrease in the reactor pressure, to indicate a successful run.

Ethylene was then added using a pressure controller to maintain the reaction pressure set point in the reactor. The polymerizations were run for set time or ethylene uptake, after which, the agitator was stopped, and the bottom dump valve was opened to empty the reactor contents into dump pot. The pot contents were poured into trays, which were placed in a fume hood, and the solvent was allowed to evaporate overnight. The trays containing the remaining polymer were then transferred to a vacuum oven, and heated to 100° C., under reduced pressure, to remove any residual solvent. After cooling to ambient temperature, the polymers were weighed for yield/efficiencies, transferred to containers for storage, and submitted for analytical testing. Polymerization conditions are listed in Table 1A, and catalysts are shown in Table 1B. The polymer properties of each ethylene/octene/silane interpolymer (SiH—POE) and ethylene/octene interpolymer (POE) are shown in Tables 2A and 2B.

The interpolymers SiH—POE D, SiH—POE E, SiH—POE F, SiH—POE G, SiH—POE H, POE D, POE E, and POE F were each prepared in a one gallon polymerization reactor that was hydraulically full, and operated at steady state conditions. POE B was prepared using a loop reactor, and the reactor was hydraulically full and operated at steady state conditions. The detailed synthesis information is provided for several of the listed examples. The solvent was ISOPAR-E, supplied by the ExxonMobil Chemical Company. 5-Hexenyldimethylsilane (HDMS) supplied by Gelest was used as a termonomer and was purified over AZ-300 alumina supplied by UOP Honeywell prior to use. HDMS was fed to the reactor as a 22 wt % solution in ISOPAR-E. The reactor temperature was measured at or near the exit of the reactor. The interpolymer was isolated and pelletized. Polymerization conditions are listed in Table 1C-1E, and catalysts are shown in Table 1B. The polymer properties of each ethylene/octene/silane interpolymer (SiH—POE) and ethylene/octene interpolymer (POE) are shown in Tables 2A and 2B.

TABLE 1A
Polymerization Conditions to produce SiH-POE

| | | | Reactor | Ethylene | Octene | Silane | Solvent | H₂ | Run |
|---|---|---|---|---|---|---|---|---|---|
| | | Reactor | Pressure | loaded | loaded | monomer | loaded | loaded | Time |
| Resin | Catalyst | Size | (psi) | (g) | (g) | loaded (g) | (g) | (mmol) | (min) |
| SiH-POE A | PE CAT 1 | 1 gal | 104.2 | 20.9 | 100.5 | 12.2 | 1357.5 | 40.1 | 10 |
| SiH-POE B | PE CAT 1 | 2 L | 111.2 | 11.5 | 58.4 | 3.8 | 587.4 | 6.6 | 4.4 |
| SiH-POE C | PE CAT 2 | 1 gal | 103.5 | 20.4 | 160.8 | 12.2 | 1345.2 | 40.1 | 10 |
| POE A | PE CAT 3 | 2 L | 121 | 11.7 | 63.6 | 0 | 590.1 | 6.6 | 5.6 |
| POE C | PE CAT 3 | 2 L | 121 | 11.7 | 63.1 | 0 | 590.1 | 6.6 | 4.5 |

TABLE 1B
Catalysts and co-catalysts
Description

| | |
|---|---|
| Catalyst (CAT) | |
| PE CAT 1 (WO2012/027448) | 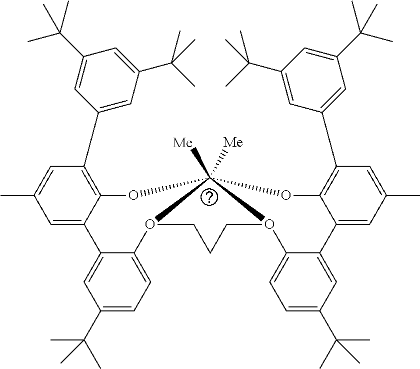 |
| PE CAT 2 (WO2012/027448) | 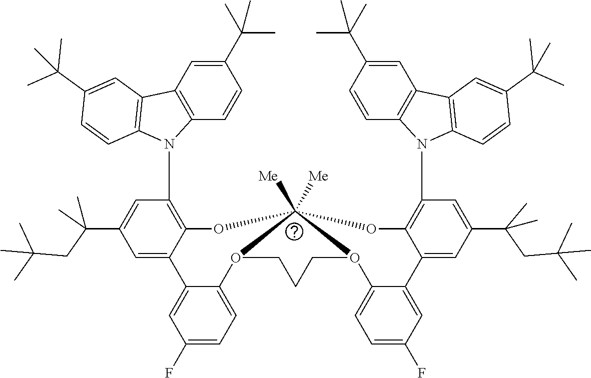 |
| PE CAT 3 | 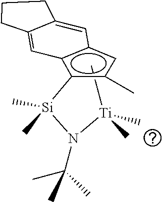 |
| PE CAT 4 (WO2018/022975) | 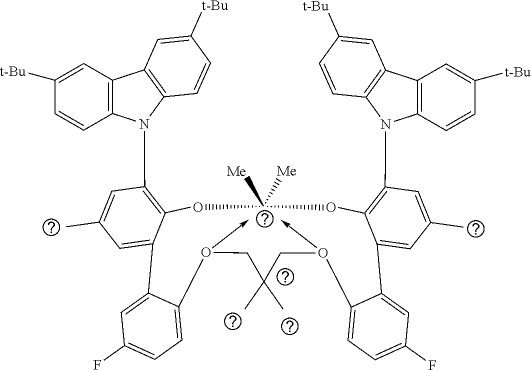 |
| Cocatalyst | |
| CoCAT-1 | A mixture of methyldi(C14-18 alkyl)ammonium salts of tetrakis(pentafluorophenyl)borate, prepared by |
| | reaction of a long chain trialkylamine (Armeen ™ M2HT, available from Akzo-Nobel, Inc.), HCl and |
| | Li[B(C6F5)4], substantially as disclosed in U.S. Pat. No. 5,919,983, Ex. 2 (no further purification |
| | performed) (Boulder Scientific) |
| CoCAT-2 | Modified methylalumoxane (MMAO) Type 3A (no further purification performed) (Akzo Nobel) |

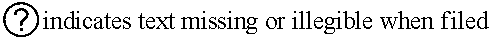

TABLE 1C
Polymerization Conditions to produce SiH-POE

| | Reactor | Reactor | | | | | | ethylene |
|---|---|---|---|---|---|---|---|---|
| | Temp., | Pressure, | Solvent, | Ethylene, | Octene, | HDMS, | Hydrogen, | conversion, |
| | ° C. | psig | lb/hr | lb/hr | lb/hr | lb/h | sccm | % |
| SiH-POE D | 170 | 729 | 38 | 3.8 | 5.0 | 1.4 | 192 | 83 |
| SiH-POE E | 168 | 726 | 36 | 3.8 | 5.0 | 2.9 | 193 | 82 |
| SiH-POE F | 170 | 725 | 22 | 4.1 | 5.6 | 1.4 | 90 | 89 |
| SiH-POE G | 170 | 725 | 17 | 3.6 | 4.2 | 3.1 | 89 | 89 |
| SiH-POE H | 170 | 727 | 16 | 3.6 | 4.4 | 2.7 | 89 | 90 |
| POE D | 170 | 728 | 39 | 3.8 | 5.4 | 0 | 162 | 83 |
| POE E | 170 | 726 | 23 | 4.1 | 6.3 | 0 | 91 | 89 |
| POE F | 170 | 726 | 22 | 3.8 | 5.1 | 0 | 91 | 89 |

TABLE 1D
Catalyst Feed Flows and Efficiency

| | | | | Overall |
|---|---|---|---|---|
| | | | | Catalyst |
| | | | | Efficiency, (g |
| | | Catalyst | Catalyst | interpolymer/g |
| | | Solution | Solution Metal | total catalyst |
| | Catalyst | Flow, lb/hr | Conc., ppm* | metal) |
| SiH-POE D | PE CAT 2 | 0.33 | 3.96 | 3,911,000 |
| SiH-POE E | PE CAT 2 | 0.57 | 3.96 | 2,385,000 |
| SiH-POE F | PE CAT 1 | 0.48 | 14.68 | 914,000 |
| SiH-POE G | PE CAT 1 | 0.17 | 14.68 | 1,798,000 |
| SiH-POE H | PE CAT 1 | 0.14 | 14.68 | 2,724,000 |
| POE D | PE CAT 2 | 0.33 | 3.96 | 3,939,000 |
| POE E | PE CAT 1 | 0.49 | 14.68 | 937,000 |
| POE F | PE CAT 1 | 0.19 | 14.68 | 1,902,000 |

*The “ppm” amount based on the weight of the respective catalyst feed solution.

TABLE 1E
Cocatalyst Feed Flows

| | CoCAT 1 | CoCAT 1 | CoCAT 2 | CoCAT 2 |
|---|---|---|---|---|
| | Solution | Solution | Solution | Solution |
| | Flow, | Conc., | Flow, | Conc., |
| | lb/hr | ppm* | lb/hr | ppm Al** |
| SiH-POE D | 0.34 | 31.25 | 0.30 | 32.2 |
| SiH-POE E | 0.58 | 31.25 | 0.53 | 32.2 |
| SiH-POE F | 0 | 0 | 0.25 | 317.9 |
| SiH-POE G | 0.29 | 154.8 | 0.29 | 14.2 |
| SiH-POE H | 0.20 | 154.8 | 0.21 | 14.2 |
| POE D | 0.33 | 31.25 | 0.31 | 32.2 |
| POE E | 0 | 0 | 0.26 | 317.9 |
| POE F | 0.29 | 154.8 | 0.30 | 14.2 |

*The “ppm” amount based on the weight of the co-catalyst feed solution.
**The “ppm” amount of Al based on the weight of the co-catalyst feed solution.

TABLE 2A
Polymer Properties

| Resin Description | | | | | Silane Information | | |
|---|---|---|---|---|---|---|---|
| | Density | | | | Silane | Silane | Silane |
| Resin | (g/cc) | MI (dg/min) | Octene (mol %) | Tₘ (C. °) | Type | mo1 %* | wt %** |
| SiH-POE A | — | — | 18.7 | 37 | ODMS^{E} | 0.80 | 3.1 |
| SiH-POE B | — | — | 15.3 | 49 | ODMS | 0.60 | 2.4 |
| SiH-POE C | — | — | 11.3 | 63 | HDMS^{F} | 0.70 | 2.5 |
| SiH-POE D | 0.873 | 0.8 | 11.0 | 64.5 | HDMS | 0.4 | 1.5 |
| SiH-POE E | 0.87 | 0.8 | 11.0 | 61.9 | HDMS | 0.9 | 3.4 |
| SiH-POE F | 0.868 | 25.8 | 11.9 | 73.5 | HMDS | 0.4 | 1.6 |
| SiH-POE G | 0.879 | 15.7 | 8.6 | 75.4 | HMDS | 1.0 | 4.0 |
| SiH-POE H | 0.876 | 20.0 | 9.1 | 74.1 | HDMS | 0.8 | 3.0 |
| POE A | — | — | 13.5 | 42 | — | — | — |
| POE B | 0.858 | 9.9 | 16.4 | 43 | — | — | — |
| POE C | — | — | 13.6 | 45 | — | — | — |
| POE D | 0.87 | 1.2 | 12.0 | 58.3 | — | — | — |
| POE E | 0.864 | 27.7 | 13.8 | 70.0 | — | — | — |
| POE F | 0.878 | 22.0 | 10.3 | 74.2 | — | — | — |
| POE 8407^{A} | 0.87 | 30 | — | 66 | — | — | — |
| POE 38669^{B} | 0.873 | 14 | — | 73 | — | — | — |
| POE 8200^{C} | 0.87 | 5 | — | 63 | — | — | — |
| EVA^{D} | 0.948 | 25 | — | — | — | — | — |

*Mol % silane based on total moles of monomers in polymer, and determined by 13C NMR (SiH-POE A and SiH-POE C), and 1H NMR (SiH-POE B).
**Wt % silane calculated from the mol %, and based on the weight of the interpolymer.
^{A}POE 8407 = ENGAGE 8407 (available from The Dow Chemical Company)
^{B}POE 38669 = XUS38669 (available from The Dow Chemical Company)
^{C}POE 8200 = ENGAGE 8200 (available from The Dow Chemical Company)
^{D}= Ethylene vinyl acetate (EVA) E282PV from Hanwha, 28 wt. % VA content
^{E}ODMS = 7-Octenyldimethylsilane.
^{F}HDMS = 5-Hexenyldimethylsilane.

TABLE 2B
Polymer Properties (Conventional GPC)

| Resin | Mn (kg/mol) | Mw (kg/mol) | Mw/Mn |
|---|---|---|---|
| SiH-POE A* | 34 | 65 | 1.9 |
| SiH-POE B** | 59 | 138 | 2.3 |
| SiH-POE C* | 34 | 71 | 2.1 |
| SiH-POE D | 49 | 108 | 2.2 |
| SiH-POE E | 45 | 100 | 2.2 |
| SiH-POE F | 24 | 50 | 2.1 |
| SiH-POE G | 25 | 53 | 2.1 |
| SiH-POE H | 25 | 52 | 2.1 |
| POE A | 50 | 119 | 2.4 |
| POE B | 32 | 73 | 2.3 |
| POE C | 52 | 135 | 2.6 |
| POE D | 52 | 112 | 2.2 |
| POE E | 24 | 50 | 2.1 |
| POE F | 26 | 52 | 2.0 |
| POE 8407 | 22 | 45 | 2.0 |
| POE 38669 | 28 | 57 | 2.0 |
| POE 8200 | 32 | 71 | 2.2 |
| EVA | — | — | — |

*Made with PE CAT 3 Each an ethylene/octene copolymer, prepared in similar manner, except the lack of silane, to the ethylene/octene/silane interpolymers, as discussed above.
**Made with PE CAT 4 - ethylene/octene copolymer, prepared in similar manner, except the lack of silane, to the ethylene/octene/silane interpolymers, as discussed above.

### Compounding Procedures

Polymer compositions (weight parts) are listed in Tables 3-6. For each composition in Table 3, the polymer pellets were melt blended with the peroxide, at the 100/1.2 weight ratio, in an RSI RS5000, RHEOMIX 600 mixer with CAM blades, at 100° C./30 RPM, for six minutes. The hot sample was cooled in a Carver press (cooled platens) at 20000 psi, for four minutes, to make a “pancake sample” for further testing (CE-1, and IE-1). For CE-2 and IE-2, the “pancake sample” was further sliced into approximately “2 mm by 2 mm by 2 mm” pieces, and sprayed with 0.5 parts of a liquid coagent (TAIC) in a glass jar, and imbibed overnight at room temperature, until all of the liquid was absorbed into the composition.

For each composition in Table 4, the polymer, the small-molecule silane (for CE-4), and the peroxide were fed sequentially into a torque rheometer (HAAKE POLYLAB QC, Thermal Scientific), equipped with a 20 mL bowl and two roller rotors, and melt blended at a temperature of 100° C. After the addition of each component, the sample was mixed at 60 RPM for one minute. The final blend was mixed for another four minutes. The hot melt was then removed from the blender for further testing.

For each composition in Table 5 and Table 6, the respective peroxide, TAIC and VMMS were mixed with the polymer pellets, according to the noted formulations, in a sealable fluoride HDPE bottle. The soaking process occurred via shaking, and then imbibed for five hours at 50° C., until no liquid residuals were visually seen adhering to the bottle.

### Study 1: Improved Peroxide Crosslinking Efficiency of Inventive Compositions

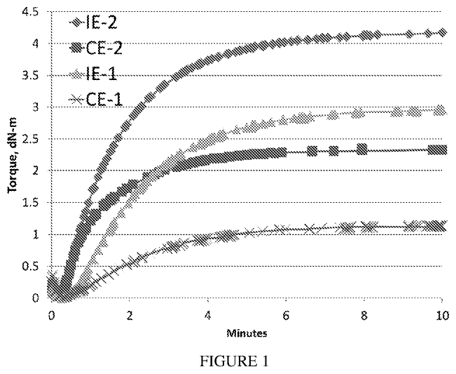

Table 3 summarizes the MDR data for the “DCP initiated crosslinking” of the compositions containing an ODMS based SiH—POE (IE-1 and IE-2) versus compositions containing a POE (CE-1 and CE-2). The crosslinking initiated by DCP occurred with and without a crosslinking coagent (TAIC). The curing effectiveness of a polymer in a “DCP formulation” can be affected by the polymer's molecular weight and its comonomer content. Thus, in the current comparison, compositions containing the SiH—POE was compared to compositions containing a POE with comparable molecular weight and comonomer content. As seen in Table 3, it was discovered that the inventive compositions each had a higher curing efficiency (MH-ML) compared to the respective comparative composition (CE-1 vs. IE-1, and CE-2 vs. IE-2). MDR profiles are shown in FIG. 1.

TABLE 3
Comparison of the Curing Efficiency for
Resin Crosslinking Initiated by DCP.

| | CE-1 | IE-1 | CE-2 | IE-2 |
|---|---|---|---|---|
| SiH-POE A | | 100 | | 100 |
| POE B | 100 | | 100 | |
| DCP* | 1.2 | 1.2 | 1.0 | 1.0 |
| TAIC** | | | 0.5 | 0.5 |

MDR at 180° C. for 15 min

| | | | | |
|---|---|---|---|---|
| ML, dN*m | 0.03 | 0.00 | 0.06 | 0.03 |
| MH, dN*m | 1.28 | 2.97 | 2.29 | 4.14 |
| MH − ML, dN*m | 1.25 | 2.97 | 2.23 | 4.11 |
| T90, min | 5.06 | 4.98 | 3.62 | 4.10 |
| Mole ratio of active | 2.85 | 3.02 | 2.37 | 2.52 |
| oxygen atom to polymer | | | | |
| Mole ratio of coagent | 0 | 0 | 0.27 | 0.27 |
| to active oxygen atom | | | | |

*DCP = Dicumyl peroxide. CAS No: 80-43-3, Molecular weight is 270 g/mol
**TAIC = Triallyl isocyanurate. CAS No: 1025-15-6, Molecular weight is 249 g/mol

Table 4 further compares the MDR data for “DCP initiated crosslinking” of a composition containing an ODMS based SiH—POE (IE-3) versus compositions containing a POE (CE-3-CE-5). In this comparison, a composition with a comparable “—SiH content” was also included (CE-4). This composition was prepared by the physical blending of a small-molecule silane (octadecyldimethylsilane (ODDMS)) to reach a level of SiH (mole %) similar to that of the inventive composition (IE-3). It was discovered that the composition containing the ODMS based SiH—POE had a substantially higher curing efficiency (MH-ML), compared to the comparative compositions (see IE-3 vs. CE-3 and CE-5). Also, the direct addition of the small-molecule silane to the formulation did not improve the curing efficiency, but decreased the curing effectiveness of the composition (CE-4 vs. CE-3). Thus, it is important that the silane group is attached to the SiH—POE backbone through a copolymerization process, to achieve a high curing efficiency.

TABLE 4
Comparison of the Curing Efficiency for
Resin Crosslinking Initiated by DCP.

| | CE-3 | CE-4 | CE-5 | IE-3 |
|---|---|---|---|---|
| SiH-POE B | | | | 98.80 |
| POE A | 98.80 | 93.80 | | |
| POE C | | | 98.80 | |
| ODDMS | | 5.00 | | |
| DCP | 1.20 | 1.20 | 1.20 | 1.20 |

MDR at 180° C. for 15 min

| | | | | |
|---|---|---|---|---|
| ML, dN*m | 0.35 | 0.22 | 0.60 | 0.86 |
| MH, dN*m | 3.24 | 0.73 | 3.88 | 8.65 |
| MH − ML, dN*m | 2.89 | 0.51 | 3.28 | 7.79 |
| T90, min | 4.00 | 4.40 | 3.66 | 3.71 |
| Mole ratio of active | 4.48 | 4.72 | 4.67 | 5.32 |
| oxygen to polymer | | | | |

Table 5 further compares the MDR data for the SiH—POE crosslinked with DCP with/without DAB coagent, it was clear that SiH—POE without coagent can curing more effective compared to the POE at comparable molecular weight at the same peroxide level (CE-27 vs. IE-22). It was also observed that after adding DAB coagent to the POE formulation, we did not observe any improvement in curing rate or curing degree (CE-27 vs. CE-28). However, when DAB was added to the SiH—POE, it was clear that the curing efficiency (i.e. MH-ML) was improved substantially (IE-22 vs. IE-23). Thus, we believed certain dicarbonyls, like DAB, can be a crosslinking coagent to the SiH—POE, while these molecules are previously considered ineffective to the regular POE materials.

TABLE 5
Comparison of the Curing Efficiency for Resin Crosslinking
Initiated by DCP and with/without the DAB coagent.

| | CE-27 | IE-22 | CE-28 | IE-23 |
|---|---|---|---|---|
| POE F | 98.8 | | 98.44 | |
| SiH-POE G | | 98.8 | | 98.44 |
| DCP | 1.2 | 1.2 | 1.2 | 1.2 |
| DAB* | | | 0.36 | 0.36 |

MDR at 180° C. for 25 min

| | | | | |
|---|---|---|---|---|
| ML, dN*m | 0.02 | 0.04 | 0 | 0.04 |
| MH, dN*m | 1.89 | 4.27 | 1.91 | 5.97 |
| MH − ML, dN*m | 1.9 | 4.2 | 1.9 | 5.9 |
| T90, min | 5.0 | 4.4 | 5.0 | 5.2 |

*DAB = 1,3-diacetylbenzene. CAS No: 6781-42-6, Molecular weight is 162.2 g/mol

Table 6 further compared both MDR data and physical performance of “DCP initiated crosslinking” of a composition containing an HDMS based SiH—POE (IE-7-IE-10) versus compositions containing a POE (CE-13-CE-15). Typically, in order to achieve higher curing efficiency, and physical properties such as lower compression set, higher modulus, and tensile strength at break; a higher level of peroxide in the formulation will be required. However, here with the help of —SiH functional group in the polymers, we observed at a comparable level of peroxide, the SiH—POE containing blend was observed to have an improved curing efficiency (i.e. MH-ML), lower C-set, and higher 300% modulus after the polymers got crosslinked (see IE-9 and IE-10 vs. CE-14). More interestingly, with even a lower level of peroxide in the SiH—POE, the crosslinked parts can have a comparable or better physical performance then regular POE peroxide formulation. For example, IE-7 with 1.2 parts peroxide can outperform CE-13 in both curing efficiency and physical performance. Similarly, IE-9 and IE-10 with 2.4 parts of peroxide were observed to have comparable C-set, better 300% modulus, tensile strength at break, and comparable elongation at break compared to CE-15 with 3.6 parts of peroxide. This can be beneficial for applications that lower level of peroxide can save cost and lead to lower level of biproducts from the peroxide decompositions.

TABLE 6
Comparison of the Physical Properties for Resin Crosslinking
Initiated by DCP.

| Formulation | IE-7 | IE-8 | CE-13 | CE-14 | CE-15 | IE-9 | IE-10 |
|---|---|---|---|---|---|---|---|
| POE D | | 70 | 100 | 100 | 100 | | 70 |
| SiH-POE D | 100 | | | | | 100 | |
| SiH-POE E | | 30 | | | | | 30 |
| DCP | 1.2 | 1.2 | 1.8 | 2.4 | 3.6 | 2.4 | 2.4 |
| Mole ratio of | 4.4 | 13.3 | 6.9 | 9.2 | 13.9 | 8.7 | 26.7 |
| active oxygen | | | | | | | |
| atom to polymer | | | | | | | |

MDR at 180° C. 15 min

| | | | | | | | |
|---|---|---|---|---|---|---|---|
| ML, dN*m | 0.5 | 0.4 | 0.4 | 0.4 | 0.4 | 0.5 | 0.4 |
| MH-ML, dN*m | 7 | 5.8 | 5.2 | 6.2 | 8.3 | 10.3 | 9.4 |
| T90, min | 3.7 | 3.9 | 3.6 | 3.4 | 3.2 | 3.4 | 3.5 |

Physical testing

| | | | | | | | |
|---|---|---|---|---|---|---|---|
| C-set, % | 12.5 | 20.2 | 15.7 | 8.5 | 5.3 | 5.3 | 6.2 |
| 300% modulus, | 5.2 | 4.7 | 4.4 | 4.4 | 4.6 | 5.6 | 5.1 |
| MPa | | | | | | | |
| Tensile strength | 14.5 | 9.9 | 14.0 | 10.2 | 5.9 | 6.7 | 7.6 |
| at break, MPa | | | | | | | |
| Elongation at | 714 | 588 | 841 | 689 | 400 | 358 | 412 |
| break, % | | | | | | | |

### Study 2: Improved Curing Rate in Presence of Coagent and VMMS for Photovoltaics (PV) Encapsulant Film Formulation

Table 7 further compares the MDR data for a composition containing a HDMS based SiH—POE (IE-4) versus a composition containing a POE (CE-6). The crosslinking was initiated by TBEC (a peroxide) in presence of VMMS (an adhesion promoter) and TAIC (crosslinking coagent). The current comparison represents the use of the inventive composition in a PV encapsulant film formulation (that is, IE-4 is similar to a formulation used commercially). It was discovered that the SiH—POE based formulation crosslinked to a substantially higher degree (MH-ML), and had reduced time (up to 35%) to achieve 90% (T90) of cure at 150° C. Both the increase in the degree of crosslinking and the decrease in the T90 are desired features to reduce cycle time for the crosslinking of manufactured parts, and to potentially reduce the use of expensive coagents and adhesion promoters in the formulations.

TABLE 7
Comparison of SiH-POE, and POE with Comparable Molecular Weight
and Comonomer Content in PV Encapsulant Film Formulation.

| | CE-6 | IE-4 |
|---|---|---|
| SiH-POE C | | 98.25 |
| POE 8200 | 98.25 | |
| TBEC* | 1.00 | 1.00 |
| TAIC | 0.50 | 0.50 |
| VMMS** | 0.25 | 0.25 |
| Total | 100.00 | 100.00 |

MDR at 150° C. for 30 min

| | | |
|---|---|---|
| ML, dN*m | 0.17 | 0.10 |
| MH, dN*m | 5.63 | 6.33 |
| MH − ML, dN*m | 5.46 | 6.23 |
| T90, min | 10.28 | 6.64 |
| Mole ratio of active | 2.65 | 2.82 |
| oxygen to polymer | | |
| Mole ratio of coagent | 0.25 | 0.25 |
| to active oxygen atom | | |

*TBEC = tert-Butylperoxy-2-ethylhexyl carbonate, Arkema, CAS No. 34443-12-4, molecular weight is 246 g/mol
**VMMS = methacryloylpropyltrimethoxysilane, CAS No: 2530-85-0, molecular weight is 248 g/mol

Table 8 further compare the SiH—POE to the POE with comparable molecular weight and comonomer content in PV encapsulant film formulation, and the faster curing features of the polymers can be identified from gel content measurements at different lamination time. This is another important characteristic for the crosslinked formulations. We observed a clearly higher gel content than regular POE materials, particularly at the 4+4 min curing time. Thus, it suggests that having—SiH functional group, the polymer curing speed can be substantially improved and form gel network well ahead of the regular POE materials.

TABLE 8
Comparison of Gel Contents Achieved from SiH-POE,
and POE with Comparable Molecular Weight and Comonomer
Content in PV Encapsulant Film Formulation.

| | CE-16 | IE-11 |
|---|---|---|
| POE E | 98.5 | |
| SiH-POE F | | 98.5 |
| TBEC | 1 | 1 |
| TAIC | 0.5 | 0.5 |
| VMMS | 0.25 | 0.25 |

Gel content measurement after lamination

| | | |
|---|---|---|
| Gel content at 4 + 4 min | 1% | 52% |
| Gel content at 4 + 6 min | 48% | 71% |
| Gel content at 4 + 8 min | 71% | 82% |

Table 9: Comparison of SiH—POE, and POE with Comparable Molecular Weight and molecular weight in TBEC peroxide and two other types of coagents that can potentially be used in PV encapsulant film applications. It was again clear that the SiH—POE in the formulation was able to be crosslinked substantially faster than the regular POEs using the same coagents and peroxide, i.e. smaller T90 when comparing IE-12 vs. CE-17, IE-13 vs. CE-18, and IE-14 vs. CE-19.

TABLE 9
Comparison of SiH-POE, and POE with Comparable Molecular
Weight and Comonomer Content in PV Encapsulant Film
Formulation at the Same Level of Peroxide with Coagents.

| | CE-17 | IE-12 | CE-18 | IE-13 | CE-19 | IE-14 |
|---|---|---|---|---|---|---|
| POE F | 98.5 | | 98.31 | | 98.41 | |
| SiH-POE G | | 98.5 | | 98.31 | | 98.41 |
| TBEC | 1 | 1 | 1 | 1 | 1 | 1 |
| TAIC | 0.5 | 0.5 | | | | |
| Vinyl D4* | | | 0.69 | 0.69 | | |
| TMPTA** | | | | | 0.59 | 0.59 |

MDR at 150° C. for 25 min

| | | | | | | |
|---|---|---|---|---|---|---|
| ML | 0.02 | 0.08 | 0 | 0.02 | 0.05 | 0.05 5 |
| MH | 3.32 | 3.88 | 3.19 | 3.75 | 1.84 | 1.64 |
| MH-ML | | | | | | |
| T90 | 10.5 | 6.3 | 10.9 | 6.8 | 13.5 | 10.2 |

*Vinyl D4 = Tetramethyltetravinylcyclotetrasiloxane, Dow Inc., CAS No. 2554-06-5, molecular weight is 345 g/mol
**TMPTA = Trimethylolpropane trimethacrylate, CAS No. 3290-92-4, molecular weight is 338 g/mol

### Study 3: Selective Crosslinking of —SiH Group for New Network Microstructures

Table 10 shows the MDR data for compositions containing a HDMS based SiH—POE (IE-5 and IE-6) and comparative compositions containing EVA, POE 8407 or POE 38669 (CE-7-CE-12). The compositions were crosslinked using TRIGONOX 301 (peroxide). The comparative compositions CE-10-CE-12 showed a minimum degree of crosslinking (MH-ML) during the heating. However, a substantial degree of crosslinking was observed for the inventive compositions (IE-5 and IE-6). Such a significant difference in the amount of curing allows for the use of TRIGONOX 301 to selectively crosslink the SiH—POE/POE blends, such that a higher crosslinking density is achieved across POE chains with —SiH groups, versus POE chains without —SiH groups. This capability to introduce contrast in the crosslinking density within the polymer network of the blend can lead to polymer compositions with distinctive microstructures, improved physical performances, and/or other novel characteristics. The comparative compositions containing the EVA (CE-7, CE-8 and CE-9) each had a lower degree of crosslinking as compared to the inventive compositions. EVA are well known having better curing effectiveness compared to the POE. With addition of a small fraction of silane comonomers to the POE, we observed unexpected high curing effectiveness of the polymers, which is even better than EVA based formulations.

TABLE 10
MDR Results from Curing SiH-POE and POE with TRIGONOX 301

| | CE-7 | CE-8 | IE-5 | CE-9 | IE-6 | CE-10 | CE-11 | CE-12 |
|---|---|---|---|---|---|---|---|---|
| SiH-POE C | | | 99.08 | | 98.92 | | | |
| EVA | 99.46 | 99.08 | | 98.92 | | | | |
| POE 8407 | | | | | | 99.46 | | |
| POE 38669 | | | | | | | 99.46 | |
| POE 8200 | | | | | | | | 99.08 |
| TAIC | | | | 0.54 | 0.54 | | | |
| TRIGONOX 301* | 0.54 | 0.92 | 0.92 | 0.54 | 0.54 | 0.54 | 0.54 | 0.92 |

MDR at 200° C. for 30 min

| | | | | | | | | |
|---|---|---|---|---|---|---|---|---|
| ML, dN*m | 0.02 | 0.02 | 0.03 | 0.02 | 0.03 | 0 | 0 | 0.05 |
| MH, dN*m | 1.73 | 2.04 | 5.13 | 3.61 | 6.42 | 0.17 | 0.04 | 0.61 |
| MH-ML, dN*m | 1.71 | 2.02 | 5.1 | 3.59 | 6.39 | 0.17 | 0.04 | 0.56 |
| T90, min | 5.73 | 5.87 | 8.48 | 4.68 | 5.71 | 12.93 | NA | 8.89 |
| Mole ratio of active | | | 2.95 | | 1.73 | 1.11 | 1.42 | 2.77 |
| oxygen to polymer | | | | | | | | |
| Mole ratio of coagent | 0 | 0 | 0 | 0.43 | 0.43 | 0 | 0 | 0 |
| to active oxygen atom | | | | | | | | |

*TRIGONOX 301 is a peroxide available from AkzoNobel with 41% concentration in isoparaffins, CAS No: 24748-23-0, Molecular weight is 264 g/mol

Table 11-13 compares the MDR data for compositions having SiH—POE vs. POE crosslinked with a couple of other peroxides under their favored crosslinking conditions. In this case, it was again identified that the SiH—POE all have improved curing efficiency, i.e. higher MH-ML. For several of the studied peroxide systems, we also observed a substantial curing rate improvement: the T90 was found to be substantially lowered than the regular POE under the same peroxide formulation. Thus, we believed the peroxide response from SiH—POE can provide beneficial curing features to a large variety of peroxide systems beside what have been shown in the current case.

TABLE 11
MDR Results from Curing SiH-POE and
POE with Luperox 331 and Luperox 531

| | CE-20 | IE-15 | CE-21 | IE-16 |
|---|---|---|---|---|
| POE F | 99.37 | | | |
| SiH-POE H | | 99.37 | | |
| POE E | | | 99.3 | |
| SiH-POE F | | | | 99.3 |
| Luperox 331* | 0.63 | 0.63 | | |
| Luperox 531** | | | 0.7 | 0.7 |

MDR at 150° C. for 25 min

| | | | | |
|---|---|---|---|---|
| ML, dN*m | 0.03 | 0.08 | 0 | 0 |
| MH, dN*m | 0.29 | 2.05 | 0.14 | 0.84 |
| MH − ML, dN*m | 0.26 | 1.97 | 0.14 | 0.84 |
| T90, min | — | 9.7 | — | 13.9 |

*Luperox 331 is a peroxide available from Arkema, 1,1-di-(tert-butylperoxy)cyclohexane with CAS number 3006-86-8, Molecular weight is 260.4 g/mol
**Luperox 531 is a peroxide available from Arkema, 1,1-di-(tert-amylperoxy)cyclohexane with CAS number 15677-10-4, Molecular weight is 288.4 g/mol

TABLE 12
MDR Results from Curing SiH-POE and
POE with Luperox 331 and Luperox 531

| | CE-22 | IE-17 | CE-23 | IE-18 |
|---|---|---|---|---|
| POE-D | 99.46 | | 99.4 | |
| SiH-POE D | | 99.46 | | 99.4 |
| TBPA | 0.54 | 0.54 | | |
| TAPA | | | 0.6 | 0.6 |
| ML, dN*m | 0.62 | 0.78 | 0.62 | 0.75 |
| MH, dN*m | 3.21 | 4.31 | 2.95 | 4.46 |
| MH − ML, dN*m | 2.59 | 3.53 | 2.33 | 3.71 |
| T90, min | 12.9 | 12.1 | 8.9 | 11.0 |

*TBPA is a peroxide, tert-butylperoxyacetate, with CAS number 107-71-1, Molecular weight is 132.2 g/mol
**TAPA is a peroxide, tert-amyl peroxyacetate, with CAS number 690-83-5, Molecular weight is 146.2 g/mol

TABLE 13
MDR Results from Curing SiH-POE and POE with Di-tert-butylperoxide,
BIPB, and Luperox 101

| | CE-24 | IE-119 | CE-25 | IE-20 | CE-26 | IE-21 |
|---|---|---|---|---|---|---|
| POE F | 99.35 | | 99.35 | | 99.25 | |
| SiH-POE H | | 99.35 | | 99.35 | | 99.25 |
| Di-tert-butylperoxide* | 0.65 | 0.65 | | | | |
| Luperox 101** | | | 0.65 | 0.65 | | |
| BIPB*** | | | | | 0.75 | 0.75 |
| Total | 100 | 100 | 100 | 100 | 100 | 100 |
| | MDR at 192° C. for 25 min | | MDR at 180° C. for 25 min | | | |
| ML, dN*m | 0 | 0.01 | 0.03 | 0 | 0.01 | 0.04 |
| MH, dN*m | 1.7 | 4.58 | 1.12 | 3.52 | 1.95 | 3.97 |
| MH-ML, dN*m | 1.7 | 4.57 | 1.09 | 3.52 | 1.94 | 3.93 |
| T90, min | 6.2 | 5.5 | 10.1 | 8.9 | 9.8 | 7.3 |

*Di-tert-butylperoxide is a peroxide with CAS number 110-05-4, Molecular weight is 146.2 g/mol
**Luperox 101 is a peroxide from Arkema, 2,5-dimethyl-2,5-di(tert-butylperoxy)hexane, with CAS number 78-63-7, Molecular weight is 290.4 g/mol
***BIPB is a peroxide from Arkema, di-(tert-butylperoxyisopropyl)benzene, CAS number 25155-25-3, Molecular weight is 339.5 g/mol

1. A process to form a crosslinked composition, the process comprising thermally treating a composition that comprises the following components:
a) at least one olefin/silane interpolymer comprising at least one Si—H group,
b) at least one peroxide, and
c) optionally, at least one crosslinking coagent.

2. The process of claim 1, wherein the interpolymer of component a is an ethylene/alpha-olefin/silane interpolymer, and further an ethylene/alpha-olefin/silane terpolymer.

3. The process of claim 1 or claim 2, wherein the interpolymer of component a comprises, in polymerized form, ≥0.10 wt % of the silane, based on the weight of the interpolymer.

4. The process of any one of claims 1-3, wherein the interpolymer of component a comprises, in polymerized form, ≤40 wt % of the silane, based on the weight of the interpolymer.

5. The process of any one of claims 1-4, wherein the composition is thermally treated at a temperature ≥120° C.

6. A crosslinked composition formed by the process of any one of claims 1-5.

7. A composition that comprises the following components:
a) at least one olefin/silane interpolymer comprising at least one Si—H group,
b) at least one peroxide, and
c) optionally, at least one crosslinking coagent.

8. The composition of claim 7, wherein the olefin/silane interpolymer of component a is an ethylene/alpha-olefin/silane interpolymer.

9. The composition of claim 7 or claim 8, wherein silane is derived from a silane monomer selected from Formula 1:
A-(SiBC—O)ₓ—Si—EFH (Formula 1),
where A is an alkenyl group;
B is a hydrocarbyl group or hydrogen, C is a hydrocarbyl group or hydrogen, and where B and C may be the same or different;
H is hydrogen, and x ≥0;
E is a hydrocarbyl group or hydrogen, F is a hydrocarbyl group or hydrogen, and where E and F may be the same or different.

10. The composition of any one of claims 7-9, wherein Formula 1 is selected from the following compounds s1) through s16) below:

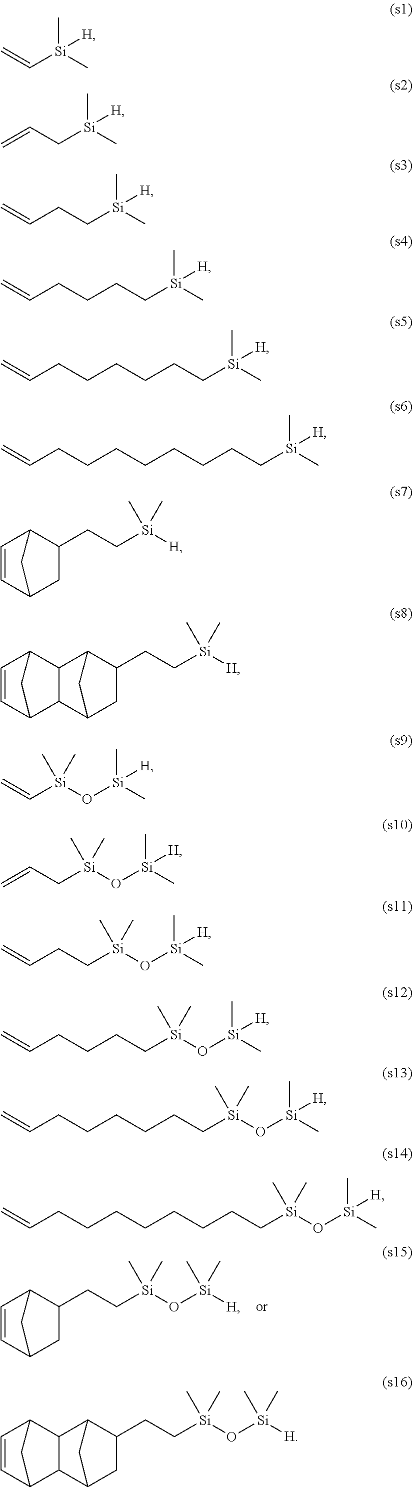

11. The composition of any one of claims 7-10, wherein the composition has a mole ratio of “the active oxygen atom in component b” to component a ≥0.5.

12. The composition of any one of claims 7-11, wherein the composition has a mole ratio of “the active oxygen atom in component b” to component a≤30.0.

13. The composition of any one of claims 7-12, wherein the composition comprises component c (at least one crosslinking coagent).

14. The composition of any one of claims 7-13, wherein the composition further comprises an ethylene/alpha-olefin interpolymer.

15. An article comprising at least one component formed from the composition of any one of claims 7-14.
